(19) United States
(12) Patent Application Publication
(10) Pub. No.: US 2021/0149476 A1
(43) Pub. Date: May 20, 2021

(54) Shared Power Rail Peak Current Manager

(71) Applicant: QUALCOMM Incorporated, San Diego, CA (US)

(72) Inventors: Ronald ALTON, Oceanside, CA (US); Todd Christopher REYNOLDS, Santee, CA (US)

(21) Appl. No.: 16/683,403

(22) Filed: Nov. 14, 2019

(51) Int. Cl. G06F 1/3296; H04W 52/02; G06F 1/3206; G06F 1/26

(52) U.S. Cl. CPC G06F 1/3296; G06F 1/263; G06F 1/3206; H04W 52/0274

(57) ABSTRACT

Various embodiments include a shared power rail monitoring circuit included in integrated circuits configured to manage worst case power on a shared power rail within the integrated circuit. Various embodiments include circuit components configured to determine allocated currents for each processing block or subsystem core on the shared power rail based on operating parameters of each processing block or subsystem core, and set a mitigation level for one or more processing blocks or subsystem cores on the shared power rail based at least in part on the determined allocated currents for each processing block or subsystem core on the shared power rail. The operating parameters may be voltage or voltage mode, temperature and operating frequency of each processing block or subsystem core.

### BACKGROUND

Modern integrated circuit products integrate numerous computational and other types of processors or “cores” combined into integrated systems. Integrating multiple processors and subsystems within a single integrated circuit or package saves real estate in devices using such components, and reduce cost and power demands. In some designs, multiple processing blocks or subsystem cores may share a power rail to enable more compact designs and reduce the number of power control circuits. However, doing so complicates the problem of ensuring that the shared power rail is not subject to power demands that exceed the capacity of the power rail.

### SUMMARY

Various aspects of the present disclosure include methods of setting worst case power limits for managing dynamic currents on shared power rails based on multiple operating factors and states within an integrated circuit. Various aspects include

Various aspects include a shared power rail monitoring circuit within an integrated circuit that may include one or more data registers within the integrated circuit configured to receive operating parameters of one or more processing blocks or subsystem cores coupled to a shared power rail, and a controller coupled to the one or more data registers and configured with executable instructions to determine allocated currents for one or more processing blocks or subsystem cores on the shared power rail based on operating parameters of each processing block or subsystem core, and set a mitigation level for one or more processing blocks or subsystem cores on the shared power rail based at least in part on the determined allocated currents for one or more processing blocks or subsystem cores on the shared power rail. In some aspects the controller may be further configured with executable instructions to determine allocated currents for one or more processing blocks or subsystem cores on the shared power rail based on operating parameters of each processing block or subsystem core by determining allocated currents using a set of lookup tables correlated to operating parameters of each processing block or subsystem.

In some aspects the controller may be further configured with executable instructions to compare a total of allocated currents for all processing blocks or subsystem cores on the shared power rail to a current limit of the shared power rail, and the controller may be further configured to set a mitigation level for one or more processing blocks or subsystem cores on the shared power rail by setting a mitigation level for one or more processing blocks or subsystem cores on the shared power rail based at least in part on the comparison of the allocated currents to the current limit of the shared power rail. In some aspects the operating parameters received on the one or more data registers may include voltage or voltage mode, temperature and operating frequency of each processing block or subsystem core coupled to a shared power rail, and the controller may be configured with executable instructions to determine allocated currents for each processing block or subsystem core on the shared power rail based on voltage or voltage mode, temperature and operating frequency of each processing block or subsystem core.

Some aspects may further include a set of leakage current and dynamic current lookup tables for each processing block or subsystem core coupled to a shared power rail, in which each leakage current table stores an allocated leakage current indexed to a voltage or voltage mode and a temperature for the respective processing block or subsystem core, and each dynamic current lookup table stores an allocated leakage current indexed to a voltage or voltage mode and a frequency of the respective processing block or subsystem core, and a rail current summing circuit configured to receive allocated leakage and dynamic currents from the lookup tables and output to the controller a total allocated current for processing blocks or subsystem cores coupled to the shared power rail. In such aspects, the controller may be coupled to the set of leakage current and dynamic current lookup tables for each processing block or subsystem core coupled to a shared power rail, and to the rail current summing circuit. In such aspects, the controller may be configured with a policy module configured to determine allocated currents for each processing block or subsystem core on the shared power rail based on operating parameters of each processing block or subsystem core by receiving voltage or voltage setting, temperature and frequency data from the processing blocks or subsystem cores, using the voltage or voltage setting, temperature and frequency data as indices in lookup tables to determine a leakage current and a dynamic current of each processing block or subsystem core on the shared power rail and summing the determined leakage and dynamic currents to determine allocated current for each processing block or subsystem core on the shared power rail, and adding the allocated currents for all processing blocks or subsystem cores on the shared power rail. In such aspects, the controller may be configured to set a mitigation level for one or more processing blocks or subsystem cores on the shared power rail based at least in part on the determined allocated currents for each processing block or subsystem core on the shared power rail by comparing a sum of the allocated currents for all processing blocks or subsystem cores on the shared power rail to a limit of the shared power rail, applying a policy to a result of the comparison to determine a mitigation level for one or more of the processing blocks or subsystem cores on the shared power rail, and communicating each determined mitigation level to a local level monitor module within a respective processing block or subsystem core.

In some aspects the controller may configured to set the mitigation level for one or more processing blocks or subsystem cores on the shared power rail based at least in part on the determined allocated currents for each processing block or subsystem core on the shared power rail by determining whether a total of the determined allocated currents of the processing blocks or subsystem cores exceeds a current limit of the shared power rail, incrementing a power mitigation level for one or more processing blocks or subsystem cores on the shared power rail in response to determining that the total of the determined allocated currents of the processing blocks or subsystem cores exceeds the current limit of the shared power rail, determining whether the total of the determined allocated currents of the processing blocks or subsystem cores is less than a hysteresis amount less than the current limit, decrementing a power mitigation level for one or more processing blocks or subsystem cores on the shared power rail in response to determining that the total of the determined allocated currents of the processing blocks or subsystem cores is less than a hysteresis amount less than the current limit, and delaying a period of time associated with the power mitigation level before again determining whether the total of the determined allocated currents of the processing blocks or subsystem cores exceeds a current limit of the shared power rail.

Some aspects may include methods of managing, by a shared power rail monitoring circuit, power demand on a shared power rail within an integrated circuit. Such aspects may include determining allocated currents for each processing block or subsystem core on the shared power rail based on operating parameters of each processing block or subsystem core, and setting a mitigation level for one or more processing blocks or subsystem cores on the shared power rail based at least in part on the determined allocated currents for each processing block or subsystem core on the shared power rail. In some aspects, determining allocated currents for one or more processing blocks or subsystem cores on the shared power rail based on operating parameters of each processing block or subsystem core may include determining allocated currents using a set of lookup tables correlated to operating parameters of each processing block or subsystem.

Some aspects may further include comparing a total of allocated currents for all processing blocks or subsystem cores on the shared power rail to a current limit of the shared power rail, in which setting a mitigation level for one or more processing blocks or subsystem cores on the shared power rail may include setting a mitigation level for one or more processing blocks or subsystem cores on the shared power rail based at least in part on the comparison of the allocated currents to the current limit of the shared power rail.

Some aspects may further include receiving a current measurement of a processing block or subsystem core by the shared power rail monitoring circuit, in which comparing the total of allocated currents for all processing blocks or subsystem cores on the shared power rail to a current limit of the shared power rail may include comparing a total of measured and allocated currents for all processing blocks or subsystem cores on the shared power rail to the current limit of the shared power rail, and setting the mitigation level for one or more processing blocks or subsystem cores on the shared power rail based at least in part on the comparison of the allocated currents to the current limit of the shared power rail may include setting the mitigation level for one or more processing blocks or subsystem cores on the shared power rail based at least in part on the comparison of the measured and allocated currents to the current limit of the shared power rail.

In some aspects, determining allocated currents for each processing block or subsystem core on the shared power rail based on operating parameters of each processing block or subsystem core may include receiving voltage or voltage setting, temperature and frequency data from the processing blocks or subsystem cores, using the voltage or voltage setting, temperature and frequency data as indices in lookup tables to determine leakage current and dynamic current of each processing block or subsystem core on the shared power rail, adding leakage currents and dynamic currents for all processing blocks or subsystem cores on the shared power rail, and providing the sum of leakage currents and dynamic currents for all processing blocks or subsystem cores on the shared power rail to a policy module of the shared power rail monitoring circuit.

In some aspects, setting a mitigation level for one or more processing blocks or subsystem cores on the shared power rail based at least in part on the determined allocated currents for each processing block or subsystem core on the shared power rail may include applying a policy, by the policy module of the shared power rail monitoring circuit, to the sum of leakage currents and/or dynamic currents for processing blocks or subsystem cores on the shared power rail to determine a mitigation level for each processing block or subsystem core on the shared power rail, and communicating each determined level to a local level monitor module within a respective processing block or subsystem core.

In some aspects using the voltage or voltage setting, temperature and frequency data as indices in lookup tables to determine leakage current and dynamic current of each processing block or subsystem core on the shared power rail may include for each processing block or subsystem core using the voltage or voltage setting and temperature of the processing block or subsystem core as indices to perform a look up in a leakage lookup table for that processing block or subsystem core to determine the leakage current for the processing block or subsystem core, and using the voltage or voltage setting and frequency of the processing block or subsystem core as indices to perform a look up in a dynamic current lookup table for that processing block or subsystem core to determine the dynamic current for the processing block or subsystem core.

In some aspects adding leakage currents and dynamic currents for all processing blocks or subsystem cores on the shared power rail may include adding the leakage current and the dynamic current for each processing block or subsystem core to determine a total allocated current for each processing block or subsystem core, providing the sum of leakage currents and dynamic currents for all processing blocks or subsystem cores on the shared power rail to the policy module of the shared power rail monitoring circuit may include providing the total allocated current for each processing block or subsystem core to the policy module of the shared power rail monitoring circuit, and setting a mitigation level for one or more processing blocks or subsystem cores on the shared power rail based at least in part on the determined allocated currents for each processing block or subsystem core on the shared power rail may include applying a policy, by the policy module of the shared power rail monitoring circuit, to the sum of leakage currents and/or dynamic currents for all processing blocks or subsystem cores and each determined allocated current for the processing blocks or subsystem cores the on the shared power rail to determine a mitigation level for each processing block or subsystem core on the shared power rail, and communicating each determined level to a local level monitor module within a respective processing block or subsystem core.

Some aspects may further include determining an operating mode of the integrating circuit, in which setting a mitigation level for one or more processing blocks or subsystem cores on the shared power rail based at least in part on the determined allocated currents for each processing block or subsystem core on the shared power rail may include setting the mitigation level for one or more processing blocks or subsystem cores on the shared power rail based at least in part on the determined operating mode and the determined allocated currents for each processing block or subsystem core on the shared power rail.

In some aspects setting the mitigation level for one or more processing blocks or subsystem cores on the shared power rail based at least in part on the determined allocated currents for each processing block or subsystem core on the shared power rail may include determining whether a total of the determined allocated currents of the processing blocks or subsystem cores exceeds a current limit of the shared power rail, incrementing a power mitigation level for one or more processing blocks or subsystem cores on the shared power rail in response to determining that the total of the determined allocated currents of the processing blocks or subsystem cores exceeds the current limit of the shared power rail, determining whether the total of the determined allocated currents of the processing blocks or subsystem cores is less than a hysteresis amount less than the current limit, decrementing a power mitigation level for one or more processing blocks or subsystem cores on the shared power rail in response to determining that the total of the determined allocated currents of the processing blocks or subsystem cores is less than a hysteresis amount less than the current limit, and delaying a period of time associated with the power mitigation level before again determining whether the total of the determined allocated currents of the processing blocks or subsystem cores exceeds a current limit of the shared power rail.

Further aspects may include an integrated circuit device having a shared power rail management circuit configured to perform one or more operations of the methods summarized above. Further aspects include a shared power rail management circuit having means for performing functions of the methods summarized above. Further aspects include a system on chip for use in a wireless device that includes an integrated circuit device having a shared power rail management circuit configured to perform one or more operations of the methods summarized above.

### BRIEF DESCRIPTION OF THE DRAWINGS

The accompanying drawings, which are incorporated herein and constitute part of this specification, illustrate exemplary aspects of the claims, and together with the general description given above and the detailed description given below, serve to explain the features of the claims.

FIG. 1 is a component block diagram illustrating a computing system of two systems-on-chip that may be configured to implement a shared power rail management circuit in accordance with various embodiments.

FIG. 2 is a circuit block diagram of a portion of an integrated circuit that includes a shared power rail monitor configured to implement a first approach for monitoring current on a shared power rail.

FIG. 3 is a graph illustrating power draws from a shared power rail by two processing blocks with power managed by the first approach for monitoring current on a shared power rail.

FIG. 4 is a circuit block diagram of a portion of an integrated circuit that includes a shared power rail monitor circuit for ensuring current on a shared power rail remains within limits according to various embodiments.

FIG. 5 is a state diagram illustrating operating states of a shared power rail monitor circuit monitoring current on a shared power rail according to various embodiments.

FIGS. 6A and 6B are examples of lookup tables for determining allocated current of a processing block or subsystem core based upon its operating states of voltage state, temperature and frequency in accordance with various embodiments.

FIG. 7 is an example table identifying different mitigation levels that may be set by a shared power rail monitor circuit according to various embodiments.

FIGS. 8A, 8B, 9A, 9B, 10 and 11 are process flow diagrams illustrating methods that may be implemented within a shared power rail monitor circuit for ensuring current on a shared power rail remains within limits according to various embodiments.

FIG. 12 is a component block diagram of a wireless device suitable for implementing dynamic thermal management for enhancing thermal performance in 5G enabled devices in accordance with various aspects of the present disclosure.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In many modern integrated circuit products, multiple processing cores, processing blocks, processor cores within various subsystems are combined into a system implemented on a single integrated circuit or chip, which are frequently referred to as a system-on-chip (SOC). Larger scale integration of multiple functionalities may be integrated within the same packaging including multiple chips, which are sometimes referred to as a system-in-package (SIP). Integrating multiple functionalities and processors and subsystem components in a single SOC reduces the physical area and volume of the electronics use in products, reduces power demands (and thus extends battery life), and reduces overall costs of the components. In some SOC designs, multiple processing blocks or subsystem cores are connected to and receive power from a common power rail, referred to herein as a shared power rail. Designing an SOC so multiple subsystem cores draw power from the same power rail simplifies the design and reduces the number of power rail management modules or circuits required in the SOC. Thus, the shared power rail architecture increases the density of functional cores on the SOC, reduces complexity, and thereby reduce costs.

However, integrating multiple processing blocks or subsystem cores on a shared power rail complicates the problem of ensuring that the power rail is not subject to power demands that exceed the capacity of the power rail. This is because independent processing blocks or subsystem cores will exhibit independent power demands on the shared power rail as their respective processes and functionalities turn on and off, and experience different loadings. For example, when the graphics processor is executing a graphics rendering process, a camera or DSP may not be operating, and thus the demand on the power rail will be driven by the graphics processor. However, if another processing block or subsystem begins a processing operation or executing a new thread, that processing block/subsystem core would draw power from the shared power rail. If many processing blocks or subsystem cores connected to the shared power rail were to execute at significant processing rates (e.g., at a maximum current draw) simultaneously, the shared power rail could experience a current that exceeds its limits. To address this problem, the shared power rail may be sized to accommodate the worst case power draw of all connected blocks/cores, or circuitry may be included in SOCs to ensure rail power or current limits are not exceeded.

One approach to ensuring rail power or current limits are not exceeded involves including a power monitoring circuitry within the SOC that receives measurements of the current drawn by certain connected processing blocks or subsystem cores, and implements restrictions or mitigation actions on processing blocks or subsystem cores so that the total current on the shared power rail does not exceed its limits Mitigation actions that may be imposed on processing blocks or subsystem cores include operating at lower frequency or voltage, and could include suspending some operations if necessary.

Factors affecting the power demand by a processing block or subsystem core include the level of activity involved in processing a computational thread, the frequency at which the core is operating, the voltage or voltage regime in which the core is operating, the temperature of that core, and the fabrication process variability of silicon.

Current drawn by processing blocks or subsystem cores connected to the shared power rail may be measured (e.g., by a current sensor), all measured currents of processing blocks or subsystem cores may be summed to determine a total current draw, and the total current compared to a limit for the shared power rail. If the shared power rail current limit is exceeded, signals may be sent to a local limits management (LLM) module within one or more processing blocks or subsystem cores to impose a mitigation level to reduce current demand.

As explained in more detail herein, this process of ensuring the measured currents of processing blocks or subsystem cores remains below a limit works well, but suffers from a need to provide a safety margin because not all processing blocks or subsystem cores include a power or current monitoring sensor providing power/current data to the power monitoring circuitry. Therefore, power mitigation actions imposed on core activities need to be implemented at a total current level that is less than the total capacity of the shared power rail in order to provide a sufficient safety margin to account for processing blocks or subsystem cores that are not directly monitored. Thus, the full capacity of the shared power rail is not utilized.

Various embodiments provide methods and circuitry for better managing power on a shared power rail by determining the leakage and dynamic current demands of processing blocks or subsystem cores based upon their operating parameters and knowledge of how those operating parameters effect the total current that may be drawn from the shared power rail. The total current that may be drawn from the shared power rail by a given processing block or subsystem core includes leakage current and/or dynamic current. The term “leakage current” refers to the amount of current drawn by a processing block or subsystem core based on temperature and voltage even in an idle state. The term “dynamic current” refers to the current drawn from the shared power rail that varies depending upon the activity level of each processing block or subsystem core. In some processing blocks or subsystem cores the leakage current may dominate, depending on the type of circuitry and processing activity. In processing blocks or subsystem cores with high activity (e.g., processing load), the dynamic current may dominate. The leakage current draw and dynamic current draw of each processing block or subsystem core under different operating conditions/activity can be determined through design analysis, simulation and/or testing, and correlated to particular operating parameters, with the results stored in lookup tables or reflected in parametric relationships. The operating parameters may include the voltage, temperature and frequency of the processing blocks or subsystem cores. Knowing these operating parameters, a controller can estimate the leakage and/or dynamic currents of each processing block or subsystem core. By estimating the total current draw that needs to be accounted for or allocated to each processing block or subsystem core based upon known operating parameters, various embodiments provide mechanisms that can better account for the worst-case and most likely demands on the shared power rail. By doing so, safety margins imposed on the operating limits of the shared power rail may be significantly reduced or eliminated. Additionally, there is less need for power manage and measuring circuitry in each processing block or subsystem core.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “processing block” is used herein to refer generally to a portion of an SOC that functions together to process data to provide a particular functionality. Processing blocks may include one or more programmable processors executing software or firmware instructions, dedicated circuitry (i.e., “hardware”) that performs the data processing, or a combination of a one or more programmable processors and dedicated circuitry. Examples of processing blocks include digital signal processors, memory controllers, cache memories, logic register banks, digital signal processors, hardened algorithm processors, network infrastructure for data flow control, read-only memory (ROM), random-access memory (RAM), interface protocol controllers, etc. The term “subsystem core” is used herein to refer generally to a portion of an SOC that functions as a subsystem and includes at least one processor core. Examples of subsystem cores include central processor units (CPUs), graphic processing units (GPUs), modem processors, audio digital signal processor (DSPs), sensor DSPs, double data rate (DDR) memory, camera/video/display processors, etc.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

Various embodiments take advantage of the fact that the leakage current and dynamic or dynamic current of a processing block or subsystem core can be predicted using a limited number of operating properties parameters, particularly, voltage temperature and operating frequency. Knowing these operating parameters, leakage and dynamic current demands of a given processing block or subsystem core can be determined using simulations, prototype and production testing, and design algorithms. For example, simulations of a design of a given processing block or subsystem core can be used to determine most likely power leakage and dynamic current demands at each of a variety of operating conditions (i.e., various combinations of voltage, temperature and frequency).

The determinations of allocated current can be made for each processing block or subsystem core present in the SOC design. This enables the determinations to account for differences in the physical designed and operating characteristics of each circuit or chip. These determinations may then be recorded in lookup tables that may be stored in non-volatile memory within the SOC. A shared rail monitoring subsystem may then use the same operating parameters (e.g., voltage, temperature and frequency) that were used in filling in the table data as look up indices. Such lookup tables may be loaded in memory at the time of manufacture or loaded or updated in a later provisioning operation. Storing leakage or current lookup tables for each processing block or subsystem core within the SOC enables a shared power rail monitoring circuit to accurately predict the dynamic current draw that is likely or possible under the current operating conditions for each processing block or subsystem core on the shared power rail using just a few operating parameters, such as voltage, temperature and operating frequency.

In some embodiments, rather than using a look up table, the same information may be implemented within predictive algorithms that can be executed using similar operating characteristics (e.g., voltage, temperature and frequency) to obtain an allocated current for the respective processing block or subsystem core.

The operating temperature of each processing block or subsystem core may be obtained by temperature sensors implemented in each core's circuitry that communicate temperature data via any of a variety of data communication circuits, such as a systemwide data bus. Temperature information may be received from the systemwide data bus by a shared rail monitoring circuit within the SOC. Voltage levels or voltage regimes of each core are known to the system and be communicated via a shared data bus. The voltage or voltage regime information may be received from the systemwide data bus by the shared rail monitoring circuitry. Operating frequency data can be written to a common system register (CSR) within the shared rail monitoring circuitry by software executing within each of processing block or subsystem core. Thus, the information needed to determine allocated currents for each processing block or subsystem core can be obtained through shared data buses and resources and then used to in a lookup table process (or in an algorithm) by the shared rail monitoring circuitry within the SOC.

The allocated currents for all processing blocks or subsystem cores on the same shared power rail may be added together in a summing circuit of the shared rail monitoring circuitry to determine an aggregate current that could be imposed (e.g., in a worst-case situation) on the shared power rail if mitigation actions are not taken in at least some processing blocks or subsystem cores. The shared rail monitoring circuitry may then compare the total of all allocated currents to one or more limits of the shared power rail. If the shared rail monitoring circuitry determines that the total allocated current draw that could be imposed on the shared power rail exceeds a limit, the shared rail monitoring circuitry may determine one or more mitigation actions that should be taken to reduce the total allocated current draw to within the limit. If the shared rail monitoring circuitry determines that the total allocated current draw that could be imposed on the a shared power rail is less than the limit by a sufficient amount, referred to herein as a hysteresis amount, the shared rail monitoring circuitry may change the mitigation level imposed on some processing blocks or subsystem cores to enable operation at higher power (e.g., at a higher operating frequency and/or voltage) to improve their performance. The hysteresis amount may serve to prevent oscillation between two or more different performance levels with one level causing the other level to cross a threshold and revert back, a situation that could impact the user experience.

In various embodiments, the shared rail monitoring circuitry may include a policy circuit or module configured to determine the level of mitigation actions to set for individual processing blocks or subsystem cores to address an over-limit or under-limit current draw situation consistent with various design targets and user operating modes. Decisions from such a policy module may then be communicated to local limit manager circuits (“LLM” in the figures) in each processing block or subsystem core that is to implement a particular mitigation level. The local limit manager is a circuit or controller that can control the operating point of its processing block or subsystem core. The local limit manager can take actions to maintain its core within the mitigation level set by the shared rail monitoring circuitry. When all processing blocks or subsystem cores operate in this manner to remain within mitigation levels set by the share power rail monitoring circuitry, the overall demand on the shared power rail will not exceed limits while permitting processing blocks or subsystem cores to operate at an appropriate power level consistent with current operations or processes of the SOC.

Mitigation actions may be taken at the processing block or subsystem core level by its local limit manager. Specifically, each local limit manager may compare the operating state of its core (e.g., current, voltage, frequency or other operational parameter defined by a mitigation level) to the operating state limit(s) defined by the mitigation level set by the shared rail monitoring circuitry (e.g., the policies circuit or module). If the core is exceeding the operating state limit(s) defined by the mitigation level set by the shared rail monitoring circuitry, then the local limit manager may take an action to cause the core to comply with mitigation level. Thus, if the total of allocated currents of processing blocks or subsystem cores connected to the shared power rail exceeds the total current limit of the shared rail and the operating state of a particular processing block or subsystem core exceeds its local limit as defined by a set mitigation level, then the local limit manager will take an action that will reduce the current draw by a processing block or core.

Similarly, if the total of allocated currents of all processing blocks or subsystem cores is less than a limit on the shared power rail, the shared rail monitoring circuit may set the mitigation level of individual processing blocks or cores at a lower level of mitigation (such as permitting high-frequency operations), thereby enabling individual processing blocks or subsystem cores to operate in modes with greater power consumption when operating conditions permit.

The processes of monitoring operating temperature, voltage and frequency of processing blocks or cores may be performed continuously, thereby enabling the shared rail monitoring circuit to account for and manage dynamic changes occurring within cores connected to the shared power rail. For example, if a particular subsystem core initiates an operation, function or computational thread that would benefit from a higher operating frequency (i.e., clock frequency), the new operating frequency may be written to the condition and status register (CSR in the figures), thereby enabling the shared rail monitoring circuit to update the current allocated to that particular subsystem core, and update the mitigation levels of processing blocks or subsystem cores if necessary to maintain the shared power rail within operating limits.

Various embodiments improve the performance of integrated systems that include multiple processing blocks or subsystem cores powered by a shared power rail on a single chip (i.e., an SOC) or within an integrated package (i.e., an SIP) by limiting power demands on the shared rail while enabling full use of the power capacity of the shared rail, such as by enabling processing blocks or subsystem cores to operate at greater power levels when operating conditions (e.g., temperature) permit. For example, the current allocated to one or more processing blocks or subsystem cores may be increased as the operating temperatures of processing blocks or subsystem cores within an SOC decline (e.g., may happen when a user equipment is operating in cold conditions), because the leakage current of processing blocks or subsystem cores decreases with decreasing temperature.

The term “multicore processor” may be used herein to refer to a single integrated circuit (IC) chip or chip package that contains two or more independent processing cores (e.g., CPU core, internet protocol (IP) core, graphics processing block (GPU) core, etc.) configured to read and execute program instructions. A SOC may include multiple multicore processors, and each processor in an SOC may be referred to as a core. The term “multiprocessor” may be used herein to refer to a system or device that includes two or more processing blocks configured to read and execute program instructions.

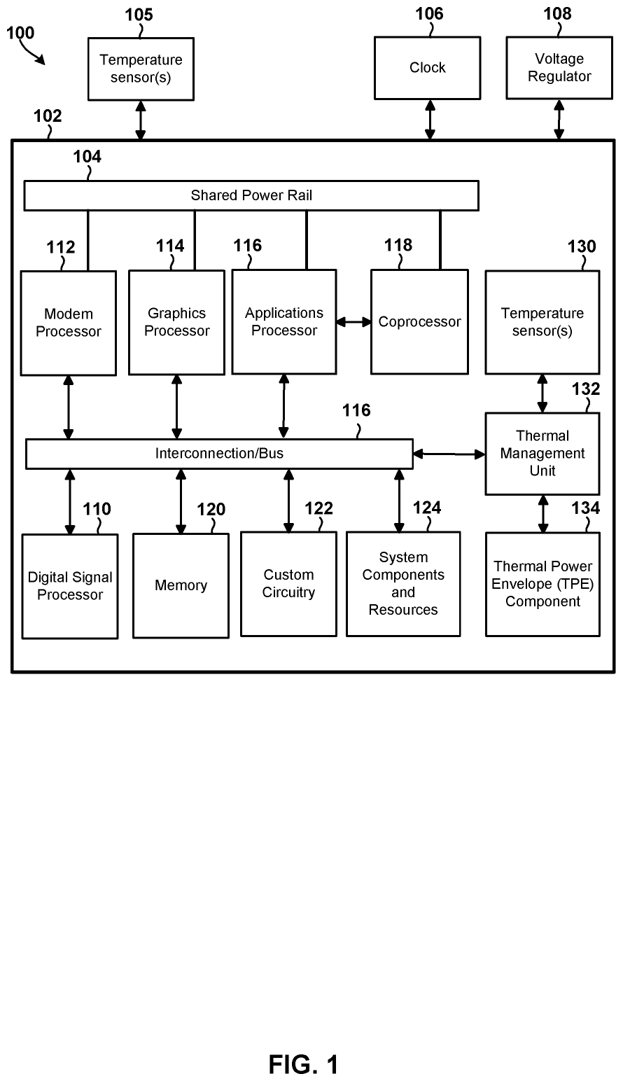

The various aspects may be implemented in a number of single processor and multiprocessor computer systems, including a system-on-chip (SOC) or system in a package (SIP). As an example, FIG. 1 illustrates components of an example SOC 100 architecture that may implement various embodiments.

The example SIP 100 illustrated in FIG. 1 an SOC 102, a temperature sensor 105, a clock 106, and a voltage regulator 108. In some aspects, the SOC 102 may operate as central processing block (CPU) of a computing device, such as a wireless device, that carries out the instructions of software application programs by performing the arithmetic, logical, control and input/output (I/O) operations specified by the instructions.

In the example illustrated in FIG. 1, the SOC 102 includes a digital signal processor (DSP) 210, a modem processor 212, a graphics processor 214, an application processor 216, one or more coprocessors 218 (e.g., vector co-processor) connected to one or more of the processors, memory 120, custom circuitry 122, system components and resources 124, an interconnection/bus module 126, one or more temperature sensors 130, a thermal management unit 132, and a thermal power envelope (TPE) component 134. One or more of the modem processor 212, graphics processor 214, application processor 216, and coprocessors 218 may be connected to and receive power from a shared power rail 104.

The thermal power envelope (TPE) component 134 may be configured to generate, manage, compare and/or evaluate one or more TPE values.

The thermal management unit 132 may be configured to monitor and manage the wireless devices surface/skin temperatures and/or the ongoing consumption of power by the active components that generate thermal energy in the wireless device.

Each processor 110, 112, 114, 116, 118 may include one or more cores, and each processor/core may perform operations independent of the other processors/cores. For example, the SOC 102 may include a processor that executes a first type of operating system (e.g., FreeBSD, LINUX, OS X, etc.) and a processor that executes a second type of operating system (e.g., MICROSOFT WINDOWS 10). In addition, any or all of the processors 110, 112, 114, 116, 118, 152, 160 may be included as part of a processor cluster architecture (e.g., a synchronous processor cluster architecture, an asynchronous or heterogeneous processor cluster architecture, etc.).

The SOC 102 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the SOC 102 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 124 and/or custom circuitry 122 may also include circuitry to interface with peripheral devices, such as cameras, electronic displays, wireless communication devices, external memory chips, etc.

The SOC 102 may further include an input/output module (not illustrated) for communicating with resources external to the SOC, such as a clock 106 and a voltage regulator 108. Resources external to the SOC (e.g., clock 106, voltage regulator 108) may be shared by two or more of the internal SOC processors/cores.

In addition to the SOC 102 discussed above, the various embodiments may be implemented in a wide variety of integrated computing systems, which may include a single processor, multiple processors, multicore processors, or any combination thereof in addition to a variety of processing blocks and subsystem cores.

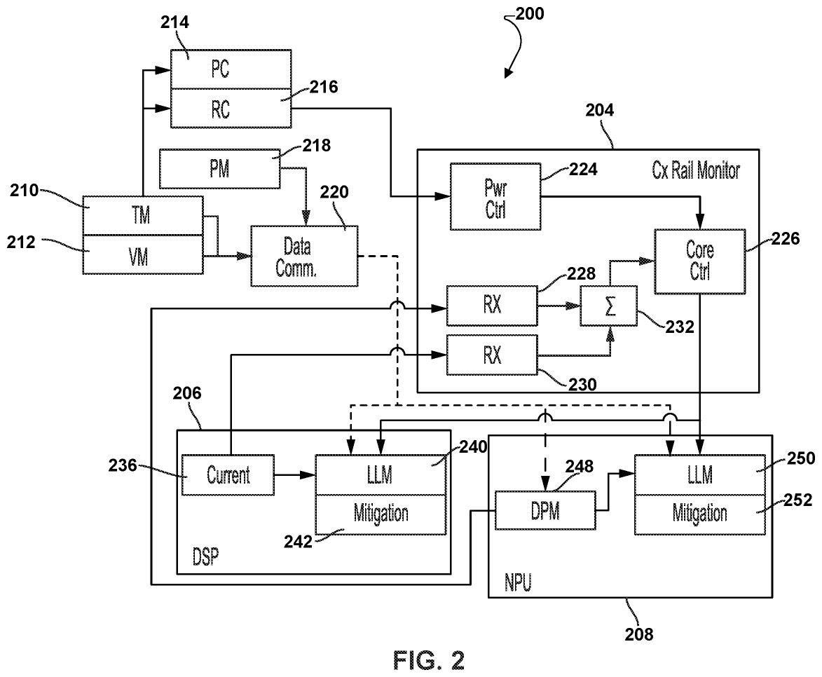

FIG. 2 is a circuit block diagram 200 illustrating portions of a large-scale integrated circuit, such as the SOC 102 illustrated in FIG. 1, including a shared rail monitor circuit 204 that interacts with processing blocks or subsystem cores on the SOC to manage power draw on a shared power rail (e.g., 104) based primarily on measurements of current or power in some processing blocks or subsystem cores. With reference to FIGS. 1-2, typical SOCs (e.g., 102) include a number of different processing blocks or subsystem cores (e.g., 110-118). In many designs, several such processing blocks or subsystem cores may be powered by a shared power rail. In order to ensure that total current demands on the shared power rail do not exceed a current limit, the shared rail monitoring circuit 204 may receive current measurements from processing blocks or subsystem cores and compare the sum of measured currents to limits, which may be set for individual blocks/cores, and initiate mitigation actions when limits are exceeded.

In the example illustrated in FIG. 2, a shared rail monitor circuit 204 may include a register for receiving power control information 224, receiver blocks (Rx) 228, 230 for receiving measured current values, a summing circuit 232 configured to add the current values from the measured current receiver blocks 228 230, and a core control module 226 configured to receive inputs from the power control register 224 and summing circuit 232, and output mitigation levels to processing blocks or subsystem cores on the shared power rail.

FIG. 2 illustrates two processing blocks coupled to the shared rail monitor circuit 204 in the form of a digital signal processor (DSP) 206 and a neural net processor unit (NPU) 208. Each of the DSP 206 and NPU 208 includes a local limits manager (LLM) 240, 250 that receives mitigation level information from the core control module 226 and conveys this information to a mitigation module 242, 252 that is configured to implement a current level mitigation setting based on the mitigation level set by the shared rail monitor circuit 204. Some processing blocks or subsystem cores may include power or current measuring elements. In the illustrated example, the DSP 206 includes a current monitoring circuit 236 that measures the current drawn by the DSP and provides measurement data to the local limits manager (LLM) 240 and to a receiver block 230 in the shared rail monitor circuit 204. Also, the NPU 208 is shown including a digital power meter (DPM) 248 that provides power measurement data to a register (RX) 228 in the shared rail monitor circuit 204. While FIG. 2 shows single examples of various circuit modules, there may be more than one of each type of circuit module within an SOC.

Similarly, the example NPU 208 includes a digital power monitor (DPM) circuit 248 configured to provide power measurement data to the local limits manager (LLM) 250 and to a receiver block 228 in the shared rail monitor circuit 204.

The shared rail monitor 204 may receive information regarding power demands, temperatures and voltages of the SOC from power monitoring (PM) circuits 218, temperature monitoring (TM) circuits 210 that are configured to receive temperature information from temperature sensors throughout the SOC die, and voltage monitor circuits (VM) 212 that are configured to receive information regarding the voltage regulators within the SOC. The temperature monitoring (TM) circuits 210 outputs temperature data to other modules, including power controllers (PC) 214, resource controllers (RC) 216, and various data communication modules 220. The power controller 214 may be configured to maintain information regarding the power condition of various subsystems within the SOC. The resource controller 216 may be configured to maintain information regarding the activity of various resources within the SOC. The power controller 214 and resource controller 216 may output information regarding the operating conditions and states of various processing blocks within the SOC to the power control receiver block 224 within the shared rail monitoring circuit 204.

In addition to receiving data from the temperature sensor controller 210 and voltage regulator monitor 212, the central broadcast module 220 may receive power state information from the power monitor (PM) circuit (PM) 218. The central broadcast module 220 may output on a shared data bus information regarding the operating state (e.g., power, temperature and voltage) of various components of the SOC. This information may be used by the local limits manager 240, 250 and digital power managers 248 of various processing blocks or subsystem cores (e.g., 206, 208).

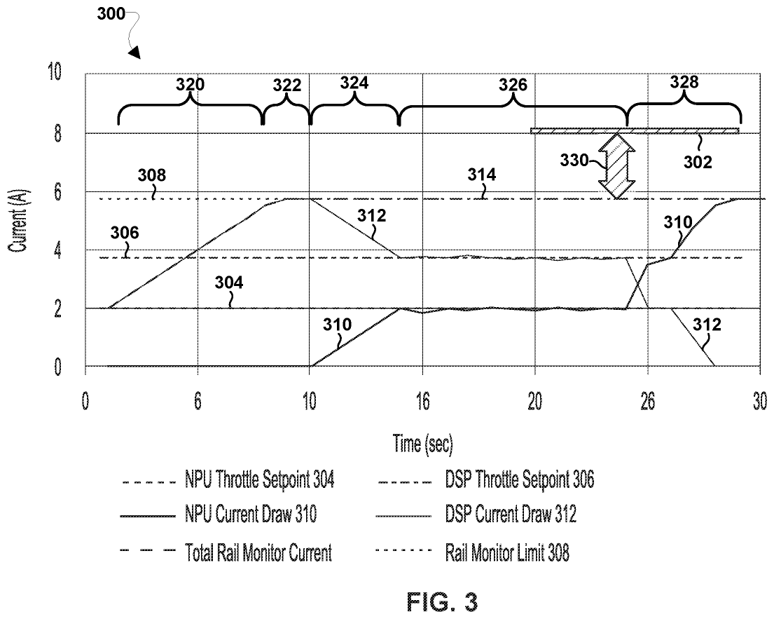

Thus, as illustrated in FIG. 2, the shared rail monitor circuit 204 issues power mitigation settings from the core controller 226 based on actual measurements of current and power of various processing blocks or subsystem cores. While controlling current and power demands of processing blocks or subsystem cores based on actual measurements functions to protect shared power rails from exceeding power current limits, this approach provides margin in the limit settings to account for processing blocks or subsystem cores for which the power or current draws are not measured. This is illustrated in FIG. 3, which is a graph showing current drawn by a DSP (e.g., 206) and an NPU (e.g., 208) sharing a common power rail when managed by a power rail monitoring circuit (e.g., 204) that relies solely on measurements of currents by some but not all processing blocks or subsystem cores on the shared power rail.

With reference to FIGS. 1-3, to ensure that the total current capacity of the shared power rail 302 (illustrated as being 8 amps (A)) is not exceeded, a rail monitor current limit 308 may be established at a current value less than the theoretical limit to account for current drawn by processing blocks or subsystem cores that do not include current sensors reporting current demand to the power rail monitoring circuit (e.g., 204). To ensure that the rail monitor current limit 308 is not exceeded by operating two or more processing blocks or subsystem cores on the shared power rail, throttle set points may be established for each processing block or subsystem core. For example, a throttle set point 304 may be set for the NPU and a throttle set point 306 may be set for the DSP, the sum of which is equal to the rail monitor current limit 308. Thus, if both the NPU and the DSP are operating at a respective throttle set point (304, 306), the total power drawn by these two processing blocks will not exceed the rail monitor current limit 308.

FIG. 3 illustrates how a power rail monitoring circuit (e.g., 204) that depends on measured current values of processing blocks or subsystem cores may impose performance limits on the blocks/cores on the same shared power rail. For example, while the NPU is deenergized or inactive and thus is not drawing significant current, as illustrated in duration 320, the DSP may be permitted to draw as much current (shown as line 312) as it may consume up to the rail monitor current limit 308. Once the DSP current reaches the rail monitor rate 308, the total measured current of the two processing blocks coupled to the shared power rail will equal the rail monitor current limit 308, and therefore the power rail monitoring circuit will send signals to the local limits management modules in the two processing blocks, which will impose limits on the DSP so that its current draw does not exceed the rail monitor current limit 308 during duration 322.

When the NPU begins processing, and thus drawing current (shown as line 310), power rail monitoring circuit will begin to send signals to the local limits management modules in the two processing blocks, which will impose limitations on the NPU so that the sum of the currents drawn by the DSP (312) and the NPU (310), which is shown as line 314, does not exceed the rail monitor current limit 308. Thus, during the duration 324, mitigation settings imposed by local limits management modules in response to signals received from the shared power rail monitoring circuit will result in the DSP reducing current draw commensurate with the increase in the current draw by the NPU until the NPU reaches the NPU throttle set point 304, and the DSP reaches the DSP throttle set point 306. While both the DSP and NPU are operating at their respective throttle set points during duration 326, the total current draw of the two processing blocks 314 is maintained below the rail monitor current limit 308.

If the DSP reduces processing activity, resulting in declining current draw, as shown in duration 328, the shared power rail monitor circuit may send signals to the local limits management modules in the two processing blocks, which will reduce mitigation settings for the NPU so that the NPU can draw more current than the NPU throttle set point, as illustrated in line 310, provided that the total power drawn by both processing blocks on the shared power rail does not exceed the rail monitor current limit 308.

FIG. 3 illustrates that while this conventional method of ensuring power demand on the shared power rail does not exceed its limits 302, the result is that a safety margin 330 is imposed to ensure that the total power demand of both measured processing block/subsystem cores and unmeasured processing blocks or subsystem cores do not exceed the limit Consequently, the power available without exceeding design limits from the shared power rail may never be fully utilized in order to provide the safety margin 330 to account for processing blocks or subsystem cores for which the current draws are not directly measured.

Various embodiments overcome limitations imposed by managing power rail currents based solely on measurements of current or power of some processing blocks or subsystem cores by using a shared power rail monitor circuit that allocates current to various processing blocks or subsystem cores based on measurable operating conditions instead of (or in addition to) measured current draw, and manages the total current on the shared power rail based on the allocated currents. This enables current management of processing blocks or subsystem cores for which there is no direct measurement of current drawn from the shared power rail. This may reduce or even eliminate the need for imposing safety margins on the total power rail current to account for processing blocks/cores for which currents are not directly measured, thus allowing the full power/current capacity of the shared power rail to be used by processing blocks or subsystem cores. This may also simplify the design requirements for various processing blocks or subsystem cores, because the need for a current measuring circuit may be reduced or eliminated.

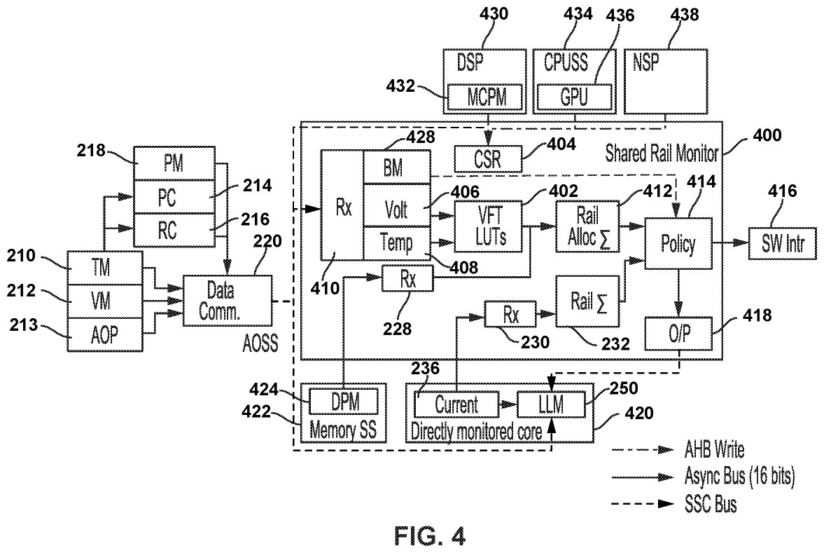

FIG. 4 is a circuit block diagram illustrating an example of a shared rail monitor circuit 400 according to various embodiments. With reference to FIGS. 1-4, the shared rail monitor circuit 400 may receive inputs from temperature monitoring (TM) circuits 210, voltage monitor circuits (VM) 212, power controllers (PC) 214, resource controllers (RC) 216, and various data communication modules 220. Also, the shared rail monitor circuit 400 may receive current data from current measuring circuits 236 from any directly monitored cores 420 on the shared power rail, with measurements data being received by a receiver block 230 and summed up by a summing circuit 232 similar to the common rail monitor circuit 204 described with reference to FIG. 2. For example, FIG. 4 shows how data regarding the current drawn from the shared power rail by a memory subsystem 422 is measured by a digital power monitor 424 and provided to a receiver block 228.

In addition to receiving current or power measurements from directly monitored cores (e.g., 420), the shared rail monitor circuit 400 may be configured to predict or estimate the total current that may be drawn from the power rail by any other processing block or subsystem core connected to the same shared power rail based on operating parameter data available in the SOC. For example, the shared rail monitor circuit 400 may receive operating state information from a DSP 430, a modem clock processing monitor (MCPM) 432 within the DSP, from a central processing block (CPU) subsystem (CPUSS) 434, such as from a graphics processor unit (GPU) 436 within that subsystem, and/or a neural net systems processor (NSP) 438.

In particular, the shared rail monitor circuit 400 may be configured to receive data regarding the voltage or voltage mode, temperature and operating frequency of each processing block or subsystem core (e.g., 430, 434, 438) via a configuration and status register (CSR) 404, bus or other communication method. The shared rail monitor circuit 400 may use this information in voltage-frequency-temperature (VFT) lookup tables (LUTs) 402 stored in memory to determine allocated currents for each processing block or subsystem core. The voltage-frequency-temperature lookup tables 402 may be any form of tables or databases accessible by or stored within a controller of the shared rail monitor circuit that correlate voltage, frequency and temperature to worst-case current draws.

The voltage-frequency-temperature lookup tables 402 may be configured (e.g., in separate or combined tables) to enable determining a predicted worst-case leakage current based on the voltage or voltage mode and temperature of a given processing block or subsystem core, and determining a predicted dynamic current demand based on the voltage or voltage mode and operating frequency of the same processing block or subsystem core. The total worst-case current draw by a given processing block or subsystem core is the sum of the predicted leakage current and predicted dynamic current. This sum is referred to herein as the “allocated current” because that amount current may be allocated to each unit/core when determining the total amount of current that could be drawn at any given instant by all processing blocks or subsystem cores connected to the same shared power rail. The shared rail monitor circuit 400 may further include a summing circuit 412 for totaling all allocated currents of processing blocks or subsystem cores determined from the voltage-frequency-temperature lookup tables 402 and other sources (e.g., 424, 228, etc.).

The shared rail monitoring circuit 400 may receive voltage or voltage mode and temperature data from a central data bus or other communication method, such as provided by the data communication module 220, which may broadcast temperature data collected by temperature monitor circuits (TM) 210 and voltage monitor circuits (VM) 212. For example, a receiver block 410 may be configured to receive the voltage and temperature data from the central broadcast and store the voltage or voltage mode data in a voltage register 406 and the temperature data into temperature register 408. The shared rail monitoring circuit 400 may receive operating frequency information for each processing block or subsystem or via a configuration and status register (CSR) 402 that may receive such data directly from various processing modules or subsystem cores or via a common data bus, such as a subsystem common (SSC) bus and/or an arm host bus (AHB). As the voltage, frequency and temperature data are obtained from standard data buses within the integrated circuit or SOC, no additional sensors or current monitoring circuits are required to obtain the operating state information required to determine allocated currents using the voltage-frequency-temperature lookup tables 402.

Total allocated currents determined by the summing circuit 412, as well as total measured currents determined by summing circuit 232, may be processed by a policy module 414. The policy module 414, which may be a dedicated controller executing firmware or a software module or algorithm executing within a controller of the overall shared rail monitoring circuit 400, determines whether the total current that could be drawn from the shared power rail exceeds a limit, which requires mitigation actions, and determines appropriate mitigation settings for processing blocks or subsystem cores to ensure that total current on the shared power rail remains within limits Mitigation settings for directly monitored cores (e.g., 420) may be communicated through an output circuit 418 to the local limit manager 250 in processing blocks or subsystem core selected for negation actions. Mitigation levels for processing blocks or subsystem cores that are not directly monitored, such as a DSP 430, a CPU subsystem 434 and a neural network system processor 438, may be communicated via a software interface 416 with power management controllers or local limits managers within those processing blocks/cores.

The policy module 414 may take into account information beyond just the total measured and allocated the currents in determining mitigation settings that should be imposed on processing blocks or subsystem cores. For example, the policy module 414 may take into account battery state and current levels in making mitigation setting decisions, such as based on information that may be received from a battery monitoring (BM) module 428, which provides information regarding battery state and drain. This enables the policy module 414 to take into account battery current limits and limit alarms when determining mitigation settings or levels for processing blocks or subsystem cores. Thus, even if the total allocated and measured currents on the shared power rail is below the limit of the power rail, the policy module 414 may impose mitigation settings sufficient to ensure that battery drain limits are not exceeded. Because the current drain on the battery is due to all subsystems across the entire device, and thus more than processing blocks or cores coupled to the shared power rail, the shared rail monitor circuit 400 may determine mitigation settings to address conditions across the entire system.

The policy module 414 may also take into account operating modes and/or applications executing on various processing blocks or subsystem cores. For example, depending upon the criticality or priority of operations executing in particular processing blocks or subsystem cores, the policy module 414 may implement mitigation settings that enable processing blocks/cores executing priority operations to operate at higher currents than would be the case if all processing blocks/cores were treated equally in determining mitigation settings necessary for current draws to remain within limits of the shared power rail. As another example, in a gaming mode, the GPU and processing blocks supporting the display may be given higher allocations, while other cores are limited first when needed to keep the shared power rail within limits. As another example, in a video mode, camera and display processing blocks may be given higher allocations, while other cores are limited first when needed to keep the shared power rail within limits.

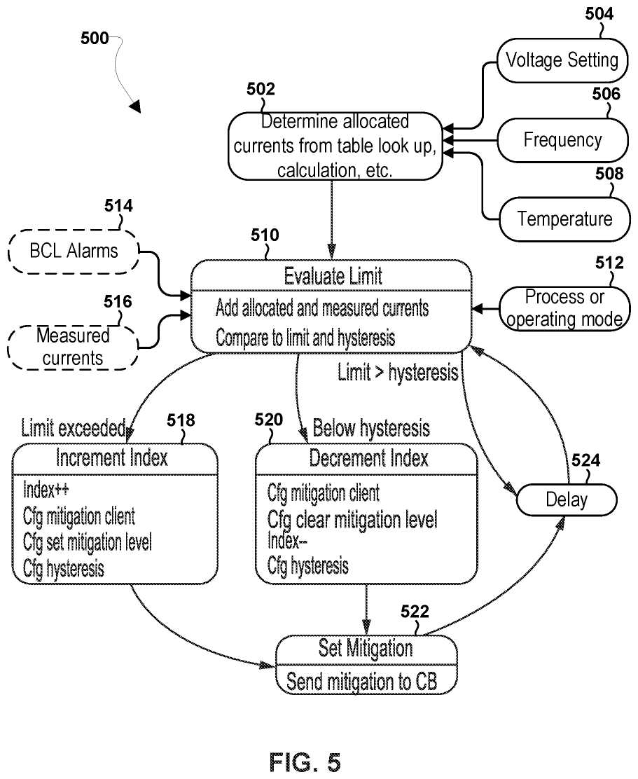

FIG. 5 is a state diagram 500 illustrating how the policy module 414 may determine mitigation settings on a continuous basis to account for changes in voltage frequency and temperature of various processing blocks or subsystem cores. As described above, in operation 502 the shared power rail monitor circuit 400 may determine allocated currents for each processing block or subsystem core coupled to a shared power rail (at least the processing blocks/cores not directly monitored) based on voltage setting data 504, operating frequency data 506 and temperature data 508 of each processing block/core.

In operating state 510, the policy module 414 may receive processor operating mode information 512, battery current limit alarms 514 and/or measured currents 516 of directly monitored cores and add all allocated and measured currents determine a total current demand on the shared power rail. In this operating state the policy module 414 may then compare the total of all current demands to the current limit of the shared power rail. If the total of all current demands is less than the limit of the shared power rail, the policy module 414 may determine whether the difference is greater than a threshold or hysteresis amount warranting reducing mitigation settings on one or more processing blocks or subsystem cores.

In response to determining that the total of allocated and measured currents exceeds the current limit the shared power rail (“limit exceeded”), the controller implementing the policy module 414 may increase a mitigation setting for one or more processing blocks or subsystem cores in operating state 518. In this state, the controller may increment an index or value associated with a mitigation level or setting as an increased amount of mitigation (i.e., actions to reduce current drawn from the power rail) is indicated. The operations in state 518 may include configuring the processing blocks or subsystem cores, configuring the mitigation level, and configuring or setting a hysteresis or threshold amount by which a decrease in the total allocated and measured currents will justify reducing the amount of mitigation actions. The configuration or mitigation action may be specific to the particular processing block or subsystem core based on some predetermined action (e.g., reducing a maximum frequency by half, dropping a radio frequency carrier, reducing frames-per-second of video, reducing video color/depth, etc.)

In response to determining that the total of allocated and measured currents is less than the current limit of the shared power rail by a threshold or hysteresis amount (“below hysteresis”), the controller implementing the policy module 414 may decrease a mitigation setting for one or more processing blocks or subsystem cores in operating state 520. The hysteresis amount may serve to prevent oscillation between two or more different performance levels with one level causing the other level to cross a threshold and revert back, a situation that could impact the user experience, such as by causing display flicker or audio noise. In this state, the controller may decrement the index or value associated with a mitigation level or setting as a decreased amount of mitigation is indicated, thereby allowing the processing blocks/core to draw more current from the power rail. The operations in state 520 may include configuring the processing blocks or subsystem cores, configuring or clearing the mitigation level, and configuring a new hysteresis appropriate for the new (now decremented) mitigation setting. The configuration may be specific to the particular processing block or subsystem core based on some predetermined action (e.g., increasing a maximum frequency by half, adding a radio frequency carrier, increasing frames-per-second of video, increasing video color/depth, etc.)

In operating state 522, the controller implementing the policy module 414 may set the mitigation level in one or more processing blocks or subsystem cores by sending the mitigation level or setting to the corresponding processing block/core, such as via a software interface 416.

In response to determining that the total of allocated and measured currents is less than the current limit of the shared power rail but greater than the threshold or hysteresis amount (“Limit>hysteresis”), the controller may make no changes to mitigation indices.

Once the determined mitigation setting has been communicated to the corresponding processing block/core or if the controller makes no changes to mitigation indices, the controller implementing the policy module 414 may delay a period of time in state 524 before entering operating state 510 to evaluate the limit again. The duration of the delay in state 524 may depend upon the particular mitigation setting determined in operating state 518 or 520. For example, in some implementations, the delay before reevaluating limits and potentially changing mitigation settings or levels may depend upon the margin provided by the mitigation setting. For example, minimal mitigation settings (e.g., no limits on processing block/core current draw) may be afforded a minimal delay because an increase in allocated and measured currents could result in exceeding a shared power rail limit. As another example, mitigation settings that impose significant reductions in processing blocks/core current draw may be afforded greater delay because responding slowly to a decrease in allocated in measured currents would not risk exceeding a power rail current limit and delay increasing the performance of a processing block or core. The delay state 524 is optional and may not be implemented in all embodiments, may be brief, or may be fixed and not dependent on particular mitigation levels.

Following the delay state 524, the controller implementing the policy module 414 may again receive information regarding the allocated and measured currents of processing blocks or subsystem cores and repeat the operations of evaluating the total current draw against limits to determine whether the mitigation setting of one or more processing block/cores is appropriate.

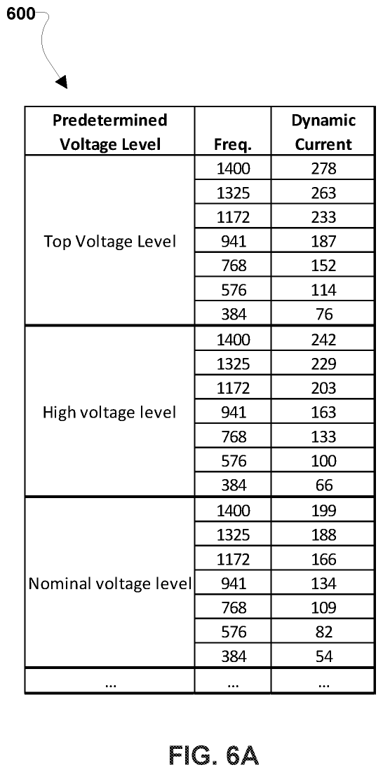

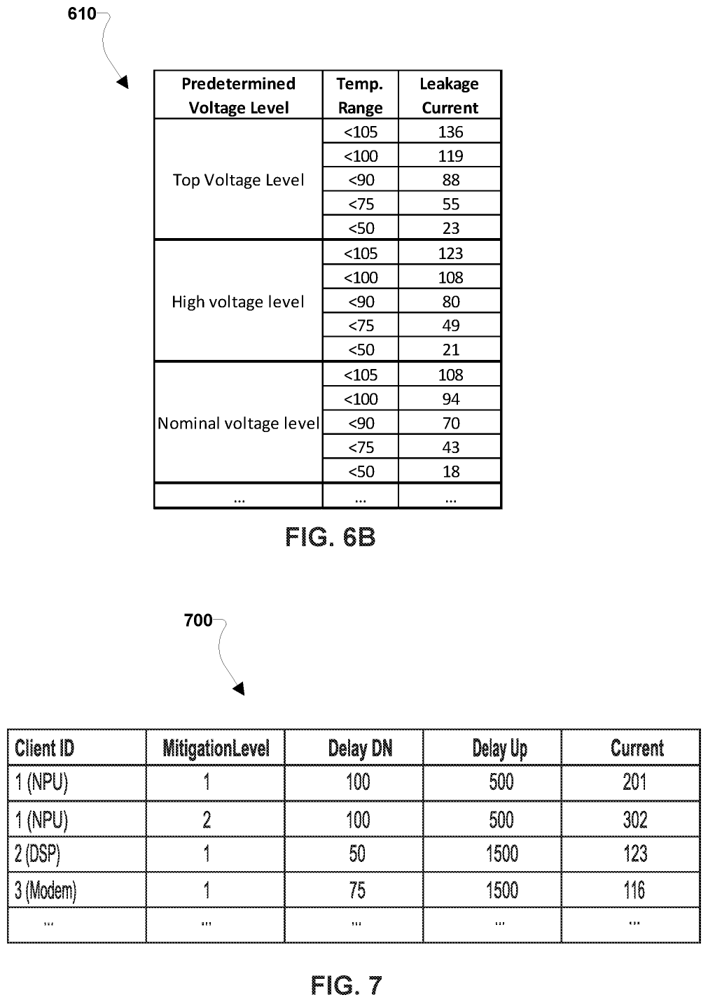

FIG. 6A is an example of a voltage-frequency lookup table 600 suitable for use with various embodiments. A voltage-frequency lookup table can be used to determine the worst case or dynamic current that could be expected for a processing block or subsystem core as a function of its voltage level and operating frequency. In this example, the voltage is controlled by the SOC in terms of voltage levels or voltage modes, with three levels defined. A controller using such a lookup table 600 could determine the worst case or dynamic current for a particular processing block or subsystem core by using the voltage level and the operating frequency to look up the worst case value stored in the third column. Such a voltage-frequency lookup table 600 may be determined and stored in memory each processing block or subsystem core connected to the shared power rail.

FIG. 6B is an example of a temperature lookup table 610 suitable for use with various embodiments. A temperature lookup table 610 can be used to determine the leakage current that could be expected for a processing block or subsystem core as a function of its voltage level and temperature. In this example, the voltage is controlled in terms of voltage levels or modes, with three levels defined. A controller using such a lookup table 610 could determine the leakage current for a particular processing block or subsystem core by using the voltage level and the temperature of the processing block/core to look up the leakage current stored in the third column. Such a voltage-temperature lookup table 610 may be determined and stored in memory each processing block or subsystem core connected to the shared power rail.

In some embodiments, mitigation settings may be defined for each type of processing block or subsystem core in a manner that can be implemented by a local limit manager and/or power management circuit within each processing block/core. For example, as illustrated in table 700 in FIG. 7, mitigation settings may be identified in terms of mitigation levels by an index or value (e.g., 1, 2, etc.) that is associated with a particular mitigation action or settings that can be implemented by the local limit manager or power management circuitry. A table similar to table 700 may be included in the shared power rail monitoring circuit for use by the policy module 414 in determining processing blocks or subsystem cores that will receive mitigation settings and the mitigation settings that should be applied to each processing block/core to maintain current trial below the limit of the shared power rail. For example, the current draw values in the right-hand column can be used by the controller implementing the policy module to identify mitigation levels for different processing blocks or subsystem cores that total to a combined current draw from the shared power rail that is within current limits Such a table also can identify to the controller executing the policy module the appropriate delay that should be implemented before the next change is made to a mitigation level for the particular processing block or subsystem core.

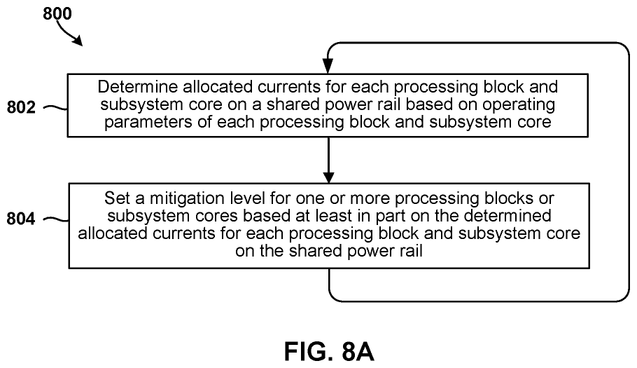

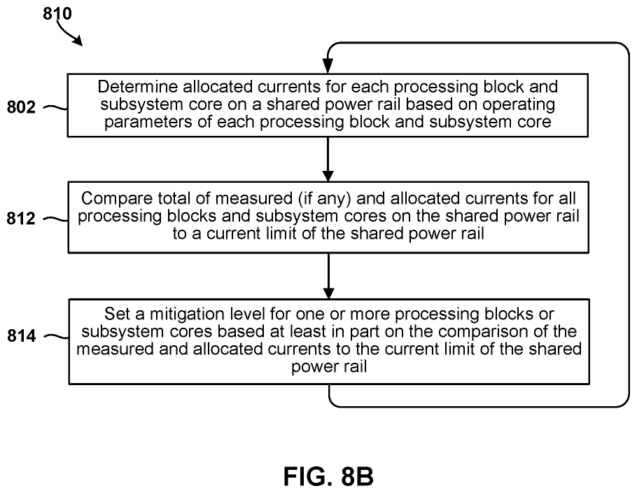

The operations of the shared power rail management circuit of various embodiments may be described in terms of a method performed by the circuit. FIG. 8A illustrates a method 800 for managing the total current in a shared power rail based on allocated currents for processing blocks or subsystem cores according to some embodiments. With reference to FIGS. 1-8A, the operations of the method 800 performed by the shared power rail management circuit (e.g. 400) may be implemented directly in circuitry, within a programmable controller configured with executable instructions to perform operations of the various embodiments, within a hardwired or preprogrammed controller configured in firmware to perform operations of various embodiments, or as combinations of dedicated circuitry, a programmable processor, and/or a preprogrammed processor. The term “controller” is used in describing the operations of the method 800 to encompass each of these alternative physical implementations of the functionality.

In block 802, the controller may determine allocated currents for each processing block or subsystem core on a shared power rail based on operating parameters of each processing block or subsystem core. As described, such operating parameters may include voltage or voltage level, temperature and operating frequency of a respective processing block or subsystem core. Such operating parameters may be received via data buses within the integrated circuit, and thus may not require current monitoring circuits within every processing block or subsystem core. As described in more detail, the operations in block 802 may involve using voltage frequency and temperature lookup tables to determine the leakage and dynamic currents of processing blocks or subsystem cores, and using information from such tables to determine total dynamic currents for each processing block or subsystem core, which may be added together to determine a total dynamic current draw that could be imposed on the shared power rail.

In block 804, the controller may set a mitigation level for one or more processing blocks or subsystem cores based at least in part on the determined allocated currents for each processing block or subsystem core on the shared power rail. Thus, instead of determining mitigation levels based on actual measured currents, mitigation levels may be set for one or more blocks/cores based on allocated or worse case currents that are determined based on operating parameters.

The method 800 may be performed periodically or continuously, such as after a given delay as described with reference to FIG. 7.

FIG. 8B illustrates a method 810 for managing the total current in a shared power rail based on allocated currents for processing blocks or subsystem cores according to some embodiments. With reference to FIGS. 1-8B, the operations of the method 810 performed by the shared power rail management circuit (e.g. 400) may be implemented directly in circuitry, within a controller configured with executable instructions to perform operations of the various embodiments, within a hardwired or preprogrammed controller configured in firmware to perform operations of various embodiments, or as combinations of dedicated circuitry, a programmable processor, or/or a preprogrammed processor. The term “controller” is used in describing the operations of the method 810 to encompass each of these alternative physical implementations of the functionality.

In block 802, the controller may determine allocated currents for each processing block or subsystem core on a shared power rail based on operating parameters of each processing block or subsystem core, as described for the like numbered block of the method 800. As described, the operations in block 802 may involve looking up allocated current draws for processing blocks or subsystem cores by using the operating parameters (e.g., voltage, temperature and frequency) as lookup indices in lookup tables stored in memory.

In block 812, the controller may compare a total of all measured currents (if any) and allocated currents for all processing blocks or subsystem cores on the shared power rail to a current limit of the shared power rail. In particular, the controller made determine whether the total of all measured and allocated currents exceeds (at least in worse case) the current limit of the shared power rail. If the total of all measured and allocated currents is less than the current limit of the shared power rail, the controller may determine whether the difference is less than a threshold or hysteresis amount appropriate for reducing the level of mitigation imposed on one or more processing blocks or subsystem cores.

In block 814, the controller may set a mitigation level for one or more processing blocks or subsystem cores based at least in part on the comparison of the total of measured and allocated currents to the current limit of the shared power rail. As described, the controller may select from a predetermined set of mitigation levels for different processing blocks or subsystem cores sufficient to ensure total measured and allocated power does not exceed a current limit on the shared power rail. In the case that the measured and allocated currents are less than the current limit of the shared power rail by a threshold or hysteresis amount, the controller may set mitigation levels for one or more processing blocks or subsystem cores that enable higher performance operations, and thus higher current draw from the shared power rail.

The method 810 may be performed periodically or continuously, such as after a given delay as described with reference to FIG. 7.

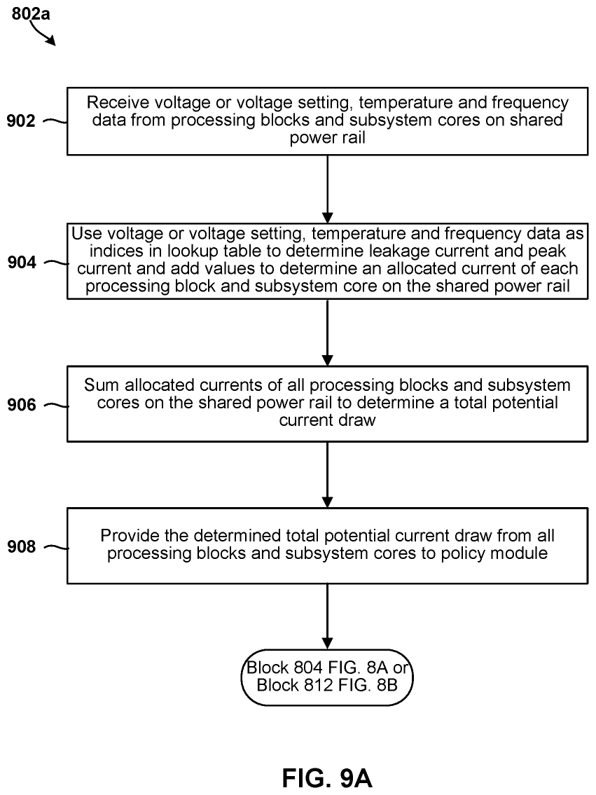

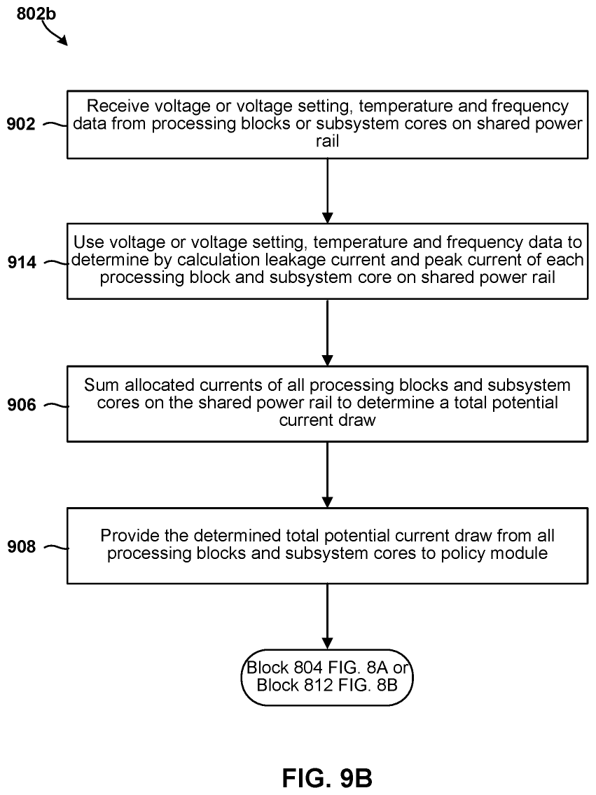

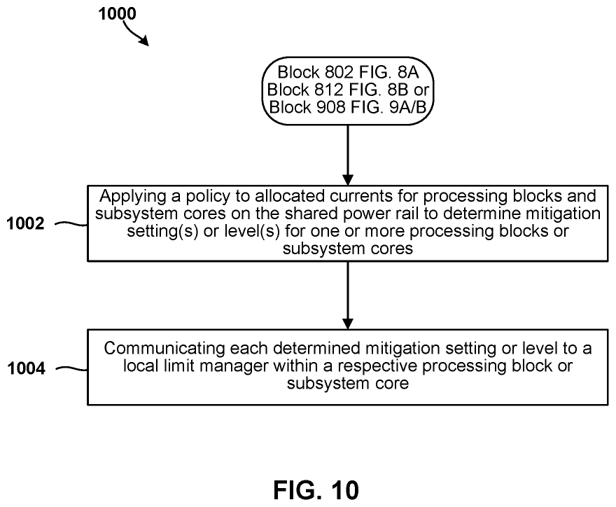

FIG. 9A illustrates operations 802a that may be performed as part of the operations in block 802 of the methods 800 and 810 according to some embodiments. With reference to FIGS. 1-9A, the operations 802a performed by the shared power rail management circuit (e.g. 400) may be implemented directly in circuitry, within a controller configured with executable instructions to perform operations of the various embodiments, within a hardwired or preprogrammed controller configured in firmware to perform operations of various embodiments, or as combinations of dedicated circuitry, a programmable processor, and/or a preprogrammed processor. The term “controller” is used in describing the operations 802a to encompass each of these alternative physical implementations of the functionality.

In block 902, the controller may receive voltage or setting, temperature and frequency data from various processing blocks or subsystem cores that are on the shared power rail. As described, this information may be received via one or more common data buses within the SOC and/or accessed by receiver blocks within the shared power rail monitoring circuit configured to receive data from various data sources, such as temperature monitor circuits 210, voltage monitor circuits 212, etc.). Operating frequency information from various processing blocks or subsystem cores may also be received via a configuration and status register (e.g., 404) coupled to a data bus within the SOC, such as an ARM host bus.

In block 904, the controller may use the received voltage or voltage setting, temperature and frequency data as indices in a table lookup process using voltage-frequency-temperature lookup tables to determine leakage current and the current for each processing block or subsystem core on the shared power rail. The operations in block 904 may involve using a separate lookup table for each processing block or subsystem core, as the leakage and dynamic currents vary for different types of processors and subsystems. Further, the lookup tables may include two portions or there may be two separate lookup tables for each processing block or subsystem core, such as one portion or lookup table for leakage current indexed to voltage of voltage setting and temperature, and one portion or lookup table for dynamic current indexed to voltage of voltage setting and operating frequency. Also as part of the operations in block 904, the controller may add the determined leakage current and dynamic current to determine a total allocated current for each processing block or subsystem core on the shared power rail.

The lookup table values may be determined through analysis, simulation and/or testing for each processing block or subsystem core. For example, circuit design tools may be used to estimate the leakage and dynamic currents for each processing block or subsystem core as functions of voltage, temperature and frequency during the design cycle. Estimating these values during the design cycle may be performed as part of sizing the shared power rail and determining which blocks or cores are connected to that rail while designing the SOC. Once the designs of the SOC are nearly fixed, detailed simulations may be run to confirm or refine the leakage and dynamic currents for each processing block or subsystem core by running simulations at different voltages, temperatures and frequencies. Finally, the values determined through design and simulation may be confirmed through prototype and/or acceptance testing of the SOC.

In block 906, the controller (or a summing circuit within or coupled to the controller) may sum the allocated currents of all processing blocks or subsystem cores on the shared power rail to determine the total potential current draw that may be imposed on the power rail. Thus, in block 906, the controller determines an amount of current that could be drawn by each processing block or subsystem core based on its operating voltage, temperature and frequency, instead of actual measurements of current drawn by each block/core. In some implementations in which current measurements are provided by some processing blocks or subsystem cores (e.g., 420, 422), the controller may sum the measured currents along with the determined allocated currents to determine the total measured plus allocated currents on the shared power rail.

In block 908, the controller (or a summing circuit) may provide the determined sum of all allocated currents to a policy module for processing in block 804 of the method 800 or block 812 of the method 810 as described. In embodiments in which the policy module is implemented as an algorithm or decision-making process executing in the controller, the operation in block 908 may be optional or simply involve accessing or making available the current sum data to the policy algorithm or decision-making process.

While FIG. 9A illustrates an example of operations 802a that involve using lookup tables to determine the allocated currents for processing blocks or subsystem cores on the shared power rail, other methods may be used to estimate the allocated currents based on the operating voltage, temperature and frequency of each block/core. FIG. 9B illustrates operations 802b that may be performed as part of the operations in block 802 of the methods 800 and 810 according to some embodiments using methods other than lookup tables. With reference to FIGS. 1-9B, the operations 802b performed by the shared power rail management circuit (e.g. 400) may be implemented directly in circuitry, within a programmable controller configured with executable instructions to perform operations of the various embodiments, within a hardwired or preprogrammed controller configured in firmware to perform operations of various embodiments, or as combinations of dedicated circuitry, a programmable processor, and/or a preprogrammed processor. The term “controller” is used in describing the operations 802b to encompass each of these alternative physical implementations of the functionality.

In block 902, the controller may perform operations of the like numbered block in operations 802a described with reference to FIG. 9A.

In block 914, the controller may use the received voltage or voltage setting, temperature and frequency data to determine by calculations the leakage current and dynamic current of each processing block or subsystem core on the shared power rail. For example, the controller may apply a formula or algorithm that correlates voltage or voltage setting and temperature to leakage current, and apply a different formula or algorithm that correlates voltage of voltage setting and operating frequency to dynamic current for each processing block or subsystem core. For example, the values of leakage current and dynamic current for each processing block or subsystem core determined through design and simulation methods, and perhaps confirmed through prototype testing, may be used to define a polynomial equation of voltage, temperature and frequency variables that approximates the determined current values. Using such a formula or algorithm instead of a lookup table may reduce the amount of memory required to support the shared power rail management circuit.

In blocks 906 and 908, the controller may perform operations of the like numbered blocks in operations 802a described with reference to FIG. 9A. The controller may then execute the operations in block 804 of the method 800 or block 812 of the method 810 as described.

FIG. 10 illustrates a method 1000 that may be performed as part of the operations in either of block 804 of the method 800 or block 814 of the method 810 to determine appropriate mitigation settings or levels for one or more processing blocks or subsystem cores according to some embodiments. With reference to FIGS. 1-10, the method 1000 performed by the shared power rail management circuit (e.g. 400) may be implemented directly in circuitry, within a programmable controller configured with executable instructions to perform operations of the various embodiments, within a hardwired or preprogrammed controller configured in firmware to perform operations of various embodiments, or as combinations of dedicated circuitry, a programmable processor, and/or a preprogrammed processor. The term “controller” is used in describing the method 1000 to encompass each of these alternative physical implementations of the functionality.

In block 1002, the controller may apply a policy (e.g., by executing a policy module or algorithm) to the total allocated currents of processing blocks or subsystem cores on the shared power rail to determine appropriate mitigation settings or levels for one or more processing blocks or subsystem cores. For example, the controller may first determine whether the total measured and allocated currents of processing blocks or subsystem cores on the shared power rail exceeds a limit of the power rail, thus requiring some form of mitigation to avoid violating the limit. If the current limit is violated by the total measured and allocated currents, the controller may apply a policy that selects individual processing blocks or subsystem cores to implement a mitigation setting or level as well as the specific mitigation setting or level to impose upon each block/core. This policy may take into account many factors, including priority of various processing blocks or subsystem cores, the amount of current reduction that can be achieved by each mitigation setting or level for each block/core, operating states of each processing block or subsystem core (which may include their respective voltage, temperature and frequency), the amount of reduction in current required to remain below the power rail current limit, operating modes or states of the SOC and/or the device in which the SOC is a component, and other types of policy considerations. The policy applied may be determined by the SOC manufacturer, the manufacturer of the device implementing the SOC, or a service provider (e.g., a cellular network provider) that provides services to the device. Further, the policy may be determined at the time of manufacture, at the time of deployment of the device, and/or updated periodically or episodically as part of normal operations.

The process of applying a policy to total allocated currents may be accomplished using a variety of algorithms. For example, a policy may be implemented in a series of decisions or a decision tree that enables making a final determination based upon the interplay of a variety of different factors. As another example, a policy may be implemented using a neural network processor that has been trained using a data set that includes various potential combinations of voltage, temperature and frequency for each of the various processing blocks or subsystem cores correlated to appropriate mitigation settings or levels. As a further example, the policy may be implemented in an iterative process that selects different combinations of mitigation levels and affected processing blocks or subsystem cores to determine through comparison a particular combination that best achieves a design goal (e.g., providing processing results commensurate with better user experience) while ensuring that the shared power rail current limit is not violated. These examples are not meant to be limiting and other methods of applying a policy to arrive at mitigation settings or levels for selected processing blocks or subsystem cores may be used.

In some embodiments, the process of applying a policy to total allocated currents in block 1002 may also take into account other state information in making mitigation setting decisions, such as battery state and current levels. For example, an applied policy may use information received from a battery monitoring module (e.g., 428) to select mitigation settings or levels to ensure battery current and/or drain limits are not exceeded.

In block 1004, the controller may communicate each determined mitigation setting or level to a local limit manager (e.g., 250) or software interface (e.g., 416) within a respective processing block or subsystem core. For example, the controller may communicate an index value associated with a set mitigation level, as illustrated in FIG. 7, and the process of implementing that level of mitigation may be accomplished by the processing block or subsystem core.

Again, following communicating the determined mitigation settings or levels to one or more processing blocks or subsystem cores, the controller may repeat the operations of the methods 800 or 810 as described.

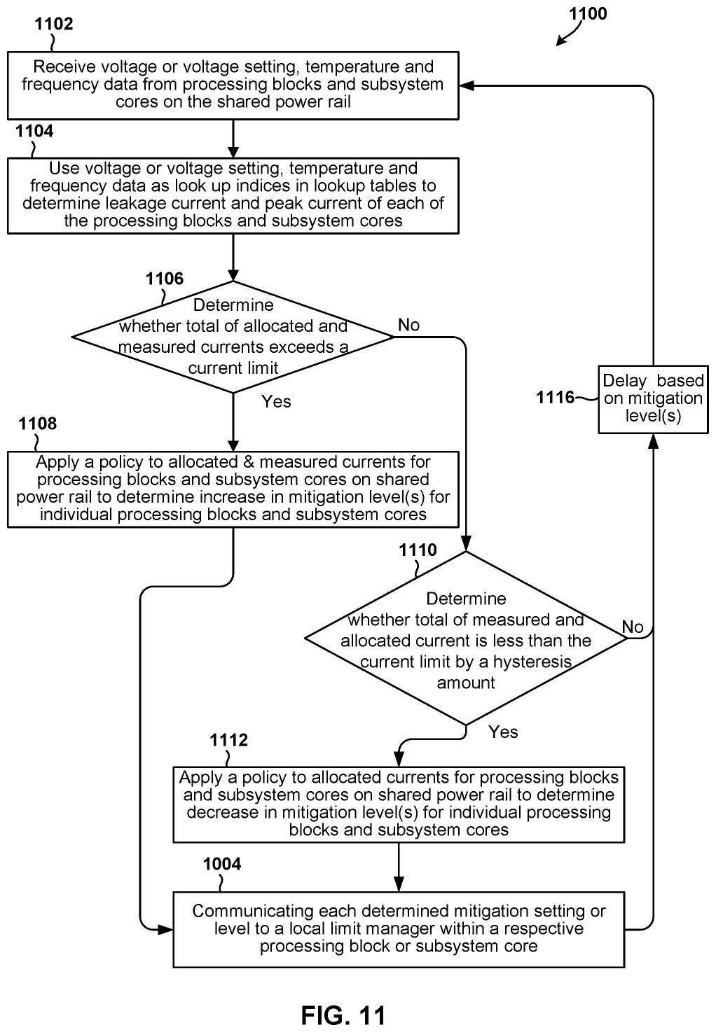

FIG. 11 illustrates a method 1100 for setting and adjusting current usage mitigation settings or levels of processing blocks or subsystem cores on a shared power rail to ensure current limits are not violated while enabling blocks/cores to operate at higher processing levels (and thus greater current draw) when operating conditions permit. Consistent with the state diagram illustrated in FIG. 5, the method 1100 may be performed in a near continuous manner so that mitigation settings and levels are adjusted consistent with changing operating conditions and processing loads of the various processing blocks or subsystem cores. With reference to FIGS. 1-11, the method 1100 performed by the shared power rail management circuit (e.g. 400) may be implemented directly in circuitry, within a programmable controller configured with executable instructions to perform operations of the various embodiments, within a hardwired or preprogrammed controller configured in firmware to perform operations of various embodiments, or as combinations of dedicated circuitry, a programmable processor, and/or a preprogrammed processor. The term “controller” is used in describing the method 1100 to encompass each of these alternative physical implementations of the functionality.

In block 1102, the controller may receive voltage or voltage setting, temperature and frequency data from the processing blocks or subsystem cores on the shared power rail as described.

In block 1104, the controller may use the received voltage or voltage setting, temperature and frequency data as lookup indices in a table lookup process using voltage, frequency and temperature lookup tables to determine leakage current and dynamic current for each processing block or subsystem core on the shared power rail. As part of the operations of block 1104, the controller may add the leakage current and dynamic current determined for each block/core to determine a total allocated current for each processing block or subsystem core.

In determination block 1106, the controller may determine whether the total of all allocated and measured currents exceeds a limit on the current that can be drawn from the shared power rail. As described, this determination may involve adding together all of the allocated currents for all processing blocks or subsystem cores to determine total allocated current, and adding any measured currents from directly monitored blocks or cores. The controller may then compare this total to the current limit of the shared power rail to determine whether the limit is exceeded.

In response to determining that the total of allocated and measured currents exceeds a current limit of the shared power rail (i.e., determination block 1106=“Yes”), the controller may apply a policy to the allocated and measured currents for processing blocks or subsystem cores on the shared power rail to determine an increase in mitigation level for one or more individual processing blocks or subsystem scores in block 1108. In embodiments in which mitigation settings or levels are identified by an index (e.g., as illustrated in FIG. 7), this operation in block 1108 may involve incrementing an index defining the mitigation setting or level for each of one or more processing blocks or subsystem cores. As described, the policy applied in block 1108 may involve selecting particular processing blocks and/or subsystem cores for which an increase in mitigation level is to be assigned, as well as selecting a mitigation level to impose on selected blocks/cores. As part of the operations in block 1108, the controller may also determine an appropriate delay to be imposed before the determine mitigation level is revised, either upward (i.e., increasing throttling of the block or core to lower current draw) or downward (i.e., reducing the amount of throttling of the block or core to permit greater current draw), as illustrated in table 7 in FIG. 7.

In some embodiments, the process of applying a policy to total allocated currents in block 1108 may also take into account other state information in making mitigation setting decisions, such as battery state and current levels. For example, an applied policy may use information received from a battery monitoring module (e.g., 428) to select mitigation settings or levels to ensure battery drain limits are not exceeded.

In response to determining that the total of allocated measured current does not exceed a current limit of the shared power rail (i.e., determination block 1106=“No”), the controller may determine whether the total of measured and allocated current is less than the current limit by at least a threshold or hysteresis amount in determination block 1110. If the total current draw on the power rail is less than the limit, it is desirable to permit at least some processing blocks or subsystem cores to increase power draw in order to allow a block/core to provide greater processing speed or capacity. However, changing mitigation levels frequently may reduce the overall performance of the system and impact the user experience. For example, if a mitigation level involves changing the resolution or frame rate of a display, users may find that changed to the acceptable provided the change is not repeated frequently, which could lead to flickering. The threshold or hysteresis amount thus ensures that there is sufficient margin between the limit and the amount of allocated current on the shared power rail to permit reducing the amount of mitigation or throttling imposed on various processing blocks or subsystem cores with little risk of having to immediately reinstate the greater mitigation setting or level.

In response to determining that the total of measured and allocated currents is less than the shared power rail current limit by at least the threshold or hysteresis amount (i.e., determination block 1110=“Yes”), the controller may apply a policy to the allocated currents for processing blocks and subsystem cores on the shared power rail to determine a suitable decrease in mitigation settings or levels for particular processing blocks or subsystem cores in block 1112. Similar to the operations in block 1108, the policy applied in block 1112 may involve selecting particular processing blocks and/or subsystem cores for which a decrease in mitigation level is to be assigned, as well as selecting a decreased mitigation level to impose on selected blocks/cores. As part of the operations in block 1112, the controller may also determine an appropriate delay to be imposed before the determined mitigation level is revised, either upward (i.e., increasing throttling of the block or core to lower current draw) or downward (i.e., reducing the amount of throttling of the block or core to permit greater current draw), as illustrated in FIG. 7.

Similar to the operations in block 1108, the policy applied in block 1112 may also take into account other state information in making mitigation setting decisions, such as battery state and current levels. For example, an applied policy may use information received from a battery monitoring module (e.g., 428) to select mitigation settings or levels to ensure battery drain limits are not exceeded.

In block 1004, the controller may communicate each mitigation setting or level determined in block 1108 or block 1112 to a local limit manager (e.g., 250) or software interface (e.g., 416) within a respective processing block or subsystem core as described for the like numbered block of the method 1000 (FIG. 10).

Following communicating the mitigation settings or levels to processing blocks or subsystem cores in block 1104 or in response to determining that the total of measured and allocated currents is not less than the shared power rail current limit by the threshold or hysteresis amount (i.e., determination block 1110=“No”), the controller may implement a delay in block 1116 that depends on one or more mitigation settings or levels imposed on one or more of the processing blocks or subsystem cores. In some embodiments, this delay in block 1116 may be set based on the longest delay corresponding to or appropriate for at least one of the mitigation settings or levels imposed on at least one of the processing blocks or subsystem cores. In some embodiments, the delay implemented by the controller in block 1116 may be applied to evaluating whether to change a mitigation setting or level of a particular processing block or subsystem core based upon its current mitigation setting or level, while permitting the controller to evaluate and adjust mitigation settings or levels for other processing blocks or subsystem cores.

After the delay in block 1116, the controller may repeat the operations of the method 1100 by again receiving operational parameters in block 1102 and again making adjustments to mitigation settings or levels of particular processing blocks and subsystem cores as described.

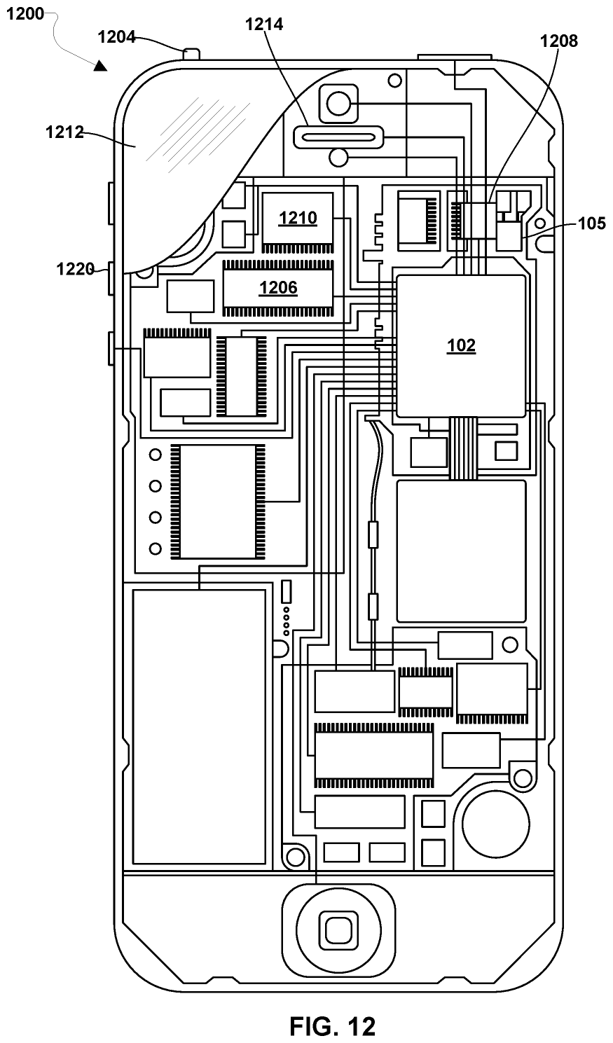

Integrated circuits, such as SOCs, may be implemented in a variety of computing systems, an example of which is illustrated in FIG. 12 in the form of a smailphone. A smailphone 1200 may include an SOC 102 (e.g., a SOC-CPU) and a temperature sensor 105. The SOC 102 may be coupled to internal memory 1206, a display 1212, and to a speaker 1214. Additionally, the smailphone 1200 may include an antenna 1204 for sending and receiving electromagnetic radiation that may be connected to a wireless data link and/or cellular telephone transceiver 1208 coupled to one or more processors in the SOC 102. Smailphones 1200 typically also include menu selection buttons or rocker switches 1220 for receiving user inputs.

A typical smartphone 1200 also includes a sound encoding/decoding (CODEC) circuit 1210, which digitizes sound received from a microphone into data packets suitable for wireless transmission and decodes received sound data packets to generate analog signals that are provided to the speaker to generate sound. Also, one or more of the processors in the SOC 102, wireless transceiver 1208 and CODEC 1210 may include a digital signal processor (DSP) circuit (not shown separately).

The controllers and processors may be any programmable microprocessor, microcomputer or multiple processor chip or chips that can be configured by software instructions (applications) to perform a variety of functions, including the functions of the various aspects described in this application. In some wireless devices, multiple processors may be provided, such as one processor dedicated to wireless communication functions and one processor dedicated to running other applications. Typically, software applications may be stored in the internal memory 1206 before they are accessed and loaded into the processor. The processor may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a controller, a controller, an object, an executable, a thread of execution, a program, and/or a computer. By way of illustration, both an application running on a wireless device and the wireless device may be referred to as a component. One or more components may reside within a process and/or thread of execution and a component may be localized on one controller or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various aspects. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iden). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The various aspects provide improved methods, systems, and devices for conserving power and improving performance in multicore processors and systems-on-chip. The inclusion of multiple independent cores on a single chip, and the sharing of memory, resources, and power architecture between cores, gives rise to a number of power management issues not present in more distributed multiprocessing systems. Thus, a different set of design constraints may apply when designing power management and voltage/frequency scaling strategies for multicore processors and systems-on-chip than for other more distributed multiprocessing systems.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect. For example, one or more of the operations of the methods may be substituted for or combined with one or more operations of the methods.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A shared power rail monitoring circuit within an integrated circuit, comprising:
one or more data registers within the integrated circuit configured to receive operating parameters of one or more processing blocks or subsystem cores coupled to a shared power rail; and
a controller coupled to the one or more data registers and configured with executable instructions to:
determine allocated currents for one or more processing blocks or subsystem cores on the shared power rail based on operating parameters of each processing block or subsystem core; and
set a mitigation level for one or more processing blocks or subsystem cores on the shared power rail based at least in part on the determined allocated currents for one or more processing blocks or subsystem cores on the shared power rail.

2. The shared power rail monitoring circuit of claim 1, wherein the controller is further configured with executable instructions to determine allocated currents for one or more processing blocks or subsystem cores on the shared power rail based on operating parameters of each processing block or subsystem core by determining allocated currents using a set of lookup tables correlated to operating parameters of each processing block or subsystem.

3. The shared power rail monitoring circuit of claim 1, wherein the controller is further configured to compare a total of allocated currents for all processing blocks or subsystem cores on the shared power rail to a current limit of the shared power rail, and
wherein the controller is further configured to set a mitigation level for one or more processing blocks or subsystem cores on the shared power rail by setting a mitigation level for one or more processing blocks or subsystem cores on the shared power rail based at least in part on the comparison of the allocated currents to the current limit of the shared power rail.

4. The shared power rail monitoring circuit of claim 1, wherein:
the operating parameters received on the one or more data registers comprises voltage or voltage mode, temperature and operating frequency of each processing block or subsystem core coupled to a shared power rail; and
the controller is configured with executable instructions to determine allocated currents for each processing block or subsystem core on the shared power rail based on voltage or voltage mode, temperature and operating frequency of each processing block or subsystem core.

5. The shared power rail monitoring circuit of claim 4, further comprising:
a set of leakage current and dynamic current lookup tables for each processing block or subsystem core coupled to a shared power rail, wherein each leakage current table stores an allocated leakage current indexed to a voltage or voltage mode and a temperature for the respective processing block or subsystem core, and each dynamic current lookup table stores an allocated leakage current indexed to a voltage or voltage mode and a frequency of the respective processing block or subsystem core; and
a rail current summing circuit configured to receive allocated leakage and dynamic currents from the lookup tables and output to the controller a total allocated current for processing blocks or subsystem cores coupled to the shared power rail.

6. The shared power rail monitoring circuit of claim 5, wherein the controller is configured with a policy module configured to:
determine allocated currents for each processing block or subsystem core on the shared power rail based on operating parameters of each processing block or subsystem core by:
receiving voltage or voltage setting, temperature and frequency data from the processing blocks or subsystem cores;
using the voltage or voltage setting, temperature and frequency data as indices in lookup tables to determine a leakage current and a dynamic current of each processing block or subsystem core on the shared power rail and summing the determined leakage and dynamic currents to determine allocated current for each processing block or subsystem core on the shared power rail; and
adding the allocated currents for all processing blocks or subsystem cores on the shared power rail; and
set a mitigation level for one or more processing blocks or subsystem cores on the shared power rail based at least in part on the determined allocated currents for each processing block or subsystem core on the shared power rail by:
comparing a sum of the allocated currents for all processing blocks or subsystem cores on the shared power rail to a limit of the shared power rail;
applying a policy to a result of the comparison to determine a mitigation level for one or more of the processing blocks or subsystem cores on the shared power rail; and
communicating each determined mitigation level to a local level monitor module within a respective processing block or subsystem core.

7. The shared power rail monitoring circuit of claim 1, wherein the controller is configured to set the mitigation level for one or more processing blocks or subsystem cores on the shared power rail based at least in part on the determined allocated currents for each processing block or subsystem core on the shared power rail by:
determining whether a total of the determined allocated currents of the processing blocks or subsystem cores exceeds a current limit of the shared power rail;
incrementing a power mitigation level for one or more processing blocks or subsystem cores on the shared power rail in response to determining that the total of the determined allocated currents of the processing blocks or subsystem cores exceeds the current limit of the shared power rail;
determining whether the total of the determined allocated currents of the processing blocks or subsystem cores is less than a hysteresis amount less than the current limit;
decrementing a power mitigation level for one or more processing blocks or subsystem cores on the shared power rail in response to determining that the total of the determined allocated currents of the processing blocks or subsystem cores is less than a hysteresis amount less than the current limit; and
delaying a period of time associated with the power mitigation level before again determining whether the total of the determined allocated currents of the processing blocks or subsystem cores exceeds a current limit of the shared power rail.

8. A method of managing power demand on a shared power rail within an integrated circuit, comprising:
determining, by a shared power rail monitoring circuit, allocated currents for each processing block or subsystem core on the shared power rail based on operating parameters of each processing block or subsystem core; and
setting, by the shared power rail monitoring circuit, a mitigation level for one or more processing blocks or subsystem cores on the shared power rail based at least in part on the determined allocated currents for each processing block or subsystem core on the shared power rail.

9. The method of claim 8, wherein determining allocated currents for one or more processing blocks or subsystem cores on the shared power rail based on operating parameters of each processing block or subsystem core comprises determining allocated currents using a set of lookup tables correlated to operating parameters of each processing block or subsystem.

10. The method of claim 8, further comprising comparing, by the shared power rail monitoring circuit, a total of allocated currents for all processing blocks or subsystem cores on the shared power rail to a current limit of the shared power rail,
wherein setting a mitigation level for one or more processing blocks or subsystem cores on the shared power rail comprises setting, by the shared power rail monitoring circuit, a mitigation level for one or more processing blocks or subsystem cores on the shared power rail based at least in part on the comparison of the allocated currents to the current limit of the shared power rail.

11. The method of claim 10, further comprising receiving a current measurement of a processing block or subsystem core by the shared power rail monitoring circuit, wherein:
comparing the total of allocated currents for all processing blocks or subsystem cores on the shared power rail to a current limit of the shared power rail comprises comparing a total of measured and allocated currents for all processing blocks or subsystem cores on the shared power rail to the current limit of the shared power rail; and
setting the mitigation level for one or more processing blocks or subsystem cores on the shared power rail based at least in part on the comparison of the allocated currents to the current limit of the shared power rail comprises setting the mitigation level for one or more processing blocks or subsystem cores on the shared power rail based at least in part on the comparison of the measured and allocated currents to the current limit of the shared power rail.

12. The method of claim 8, wherein determining allocated currents for each processing block or subsystem core on the shared power rail based on operating parameters of each processing block or subsystem core comprises:
receiving, by the shared power rail monitoring circuit, voltage or voltage setting, temperature and frequency data from the processing blocks or subsystem cores;
using, by the shared power rail monitoring circuit, the voltage or voltage setting, temperature and frequency data as indices in lookup tables to determine leakage current and dynamic current of each processing block or subsystem core on the shared power rail;
adding, by the shared power rail monitoring circuit, leakage currents and dynamic currents for all processing blocks or subsystem cores on the shared power rail; and
providing the sum of leakage currents and dynamic currents for all processing blocks or subsystem cores on the shared power rail to a policy module of the shared power rail monitoring circuit.

13. The method of claim 12, wherein setting a mitigation level for one or more processing blocks or subsystem cores on the shared power rail based at least in part on the determined allocated currents for each processing block or subsystem core on the shared power rail comprises:
applying a policy, by the policy module of the shared power rail monitoring circuit, to the sum of leakage currents and dynamic currents for processing blocks or subsystem cores on the shared power rail to determine a mitigation level for each processing block or subsystem core on the shared power rail; and
communicating each determined level to a local level monitor module within a respective processing block or subsystem core.

14. The method of claim 12, wherein using, by the shared power rail monitoring circuit, the voltage or voltage setting, temperature and frequency data as indices in lookup tables to determine leakage current and dynamic current of each processing block or subsystem core on the shared power rail comprises for each processing block or subsystem core:
using the voltage or voltage setting and temperature of the processing block or subsystem core as indices to perform a look up in a leakage lookup table for that processing block or subsystem core to determine the leakage current for the processing block or subsystem core; and
using the voltage or voltage setting and frequency of the processing block or subsystem core as indices to perform a look up in a dynamic current lookup table for that processing block or subsystem core to determine the dynamic current for the processing block or subsystem core.

15. The method of claim 12, wherein:
adding leakage currents and dynamic currents for all processing blocks or subsystem cores on the shared power rail comprises adding, by the shared power rail monitoring circuit, the leakage current and the dynamic current for each processing block or subsystem core to determine a total allocated current for each processing block or subsystem core;
providing the sum of leakage currents and dynamic currents for all processing blocks or subsystem cores on the shared power rail to the policy module of the shared power rail monitoring circuit comprises providing the total allocated current for each processing block or subsystem core to the policy module of the shared power rail monitoring circuit; and
setting a mitigation level for one or more processing blocks or subsystem cores on the shared power rail based at least in part on the determined allocated currents for each processing block or subsystem core on the shared power rail comprises:
applying a policy, by the policy module of the shared power rail monitoring circuit, to the sum of leakage currents and dynamic currents for all processing blocks or subsystem cores and each determined allocated current for the processing blocks or subsystem cores the on the shared power rail to determine a mitigation level for each processing block or subsystem core on the shared power rail; and
communicating each determined level to a local level monitor module within a respective processing block or subsystem core.

16. The method of claim 8, further comprising determining, by the shared power rail monitoring circuit, an operating mode of the integrating circuit,
wherein setting a mitigation level for one or more processing blocks or subsystem cores on the shared power rail based at least in part on the determined allocated currents for each processing block or subsystem core on the shared power rail comprises setting, by the shared power rail monitoring circuit, the mitigation level for one or more processing blocks or subsystem cores on the shared power rail based at least in part on the determined operating mode and the determined allocated currents for each processing block or subsystem core on the shared power rail.

17. The method of claim 8, wherein setting the mitigation level for one or more processing blocks or subsystem cores on the shared power rail based at least in part on the determined allocated currents for each processing block or subsystem core on the shared power rail comprises:
determining whether a total of the determined allocated currents of the processing blocks or subsystem cores exceeds a current limit of the shared power rail;
incrementing a power mitigation level for one or more processing blocks or subsystem cores on the shared power rail in response to determining that the total of the determined allocated currents of the processing blocks or subsystem cores exceeds the current limit of the shared power rail;
determining whether the total of the determined allocated currents of the processing blocks or subsystem cores is less than a hysteresis amount less than the current limit;
decrementing a power mitigation level for one or more processing blocks or subsystem cores on the shared power rail in response to determining that the total of the determined allocated currents of the processing blocks or subsystem cores is less than a hysteresis amount less than the current limit; and
delaying a period of time associated with the power mitigation level before again determining whether the total of the determined allocated currents of the processing blocks or subsystem cores exceeds a current limit of the shared power rail.

18. A shared power rail monitoring circuit configured to manage power demand on a shared power rail within an integrated circuit, comprising:
means for determining allocated currents for each processing block or subsystem core on the shared power rail based on operating parameters of each processing block or subsystem core; and
means for setting a mitigation level for one or more processing blocks or subsystem cores on the shared power rail based at least in part on the determined allocated currents for each processing block or subsystem core on the shared power rail.

19. The shared power rail monitoring circuit of claim 18, wherein means for determining allocated currents for one or more processing blocks or subsystem cores on the shared power rail based on operating parameters of each processing block or subsystem core comprises means for determining allocated currents using a set of lookup tables correlated to operating parameters of each processing block or subsystem.

20. The shared power rail monitoring circuit of claim 15, further comprising means for comparing a total of allocated currents for all processing blocks or subsystem cores on the shared power rail to a current limit of the shared power rail,
wherein means for setting a mitigation level for one or more processing blocks or subsystem cores on the shared power rail comprises means for setting a mitigation level for one or more processing blocks or subsystem cores on the shared power rail based at least in part on the comparison of the allocated currents to the current limit of the shared power rail.

21. The shared power rail monitoring circuit of claim 20, further comprising means for receiving a current measurement of a processing block or subsystem core by the shared power rail monitoring circuit, wherein:
means for comparing the total of allocated currents for all processing blocks or subsystem cores on the shared power rail to a current limit of the shared power rail comprises means for comparing a total of measured and allocated currents for all processing blocks or subsystem cores on the shared power rail to the current limit of the shared power rail; and
means for setting the mitigation level for one or more processing blocks or subsystem cores on the shared power rail based at least in part on the comparison of the allocated currents to the current limit of the shared power rail comprises means for setting the mitigation level for one or more processing blocks or subsystem cores on the shared power rail based at least in part on the comparison of the measured and allocated currents to the current limit of the shared power rail.

22. The shared power rail monitoring circuit of claim 19, wherein means for determining allocated currents for each processing block or subsystem core on the shared power rail based on operating parameters of each processing block or subsystem core comprises:
means for receiving voltage or voltage setting, temperature and frequency data from the processing blocks or subsystem cores;
means for using the voltage or voltage setting, temperature and frequency data as indices in lookup tables to determine leakage current and dynamic current of each processing block or subsystem core on the shared power rail;
means for adding leakage currents and dynamic currents for all processing blocks or subsystem cores on the shared power rail; and
means for providing the sum of leakage currents and dynamic currents for all processing blocks or subsystem cores on the shared power rail to a policy module of the shared power rail monitoring circuit.

23. The shared power rail monitoring circuit of claim 22, wherein means for setting a mitigation level for one or more processing blocks or subsystem cores on the shared power rail based at least in part on the determined allocated currents for each processing block or subsystem core on the shared power rail comprises:
means for applying a policy to the sum of leakage currents and dynamic currents for processing blocks or subsystem cores on the shared power rail to determine a mitigation level for each processing block or subsystem core on the shared power rail; and
means for communicating each determined level to a local level monitor module within a respective processing block or subsystem core.

24. The shared power rail monitoring circuit of claim 22, wherein means for using the voltage or voltage setting, temperature and frequency data as indices in lookup tables to determine leakage current and dynamic current of each processing block or subsystem core on the shared power rail comprises for each processing block or subsystem core:
means for using the voltage or voltage setting and temperature of the processing block or subsystem core as indices to perform a look up in a leakage lookup table for that processing block or subsystem core to determine the leakage current for the processing block or subsystem core; and
means for using the voltage or voltage setting and frequency of the processing block or subsystem core as indices to perform a look up in a dynamic current lookup table for that processing block or subsystem core to determine the dynamic current for the processing block or subsystem core.

25. The shared power rail monitoring circuit of claim 22, wherein:
means for adding leakage currents and dynamic currents for all processing blocks or subsystem cores on the shared power rail comprises means for adding the leakage current and the dynamic current for each processing block or subsystem core to determine a total allocated current for each processing block or subsystem core;
means for providing the sum of leakage currents and dynamic currents for all processing blocks or subsystem cores on the shared power rail to the policy module of the shared power rail monitoring circuit comprises means for providing the total allocated current for each processing block or subsystem core to the policy module of the shared power rail monitoring circuit; and
means for setting a mitigation level for one or more processing blocks or subsystem cores on the shared power rail based at least in part on the determined allocated currents for each processing block or subsystem core on the shared power rail comprises:
means for applying a policy to the sum of leakage currents and dynamic currents for all processing blocks or subsystem cores and each determined allocated current for the processing blocks or subsystem cores the on the shared power rail to determine a mitigation level for each processing block or subsystem core on the shared power rail; and
means for communicating each determined level to a local level monitor module within a respective processing block or subsystem core.

26. The shared power rail monitoring circuit of claim 18, further comprising means for determining an operating mode of the integrating circuit,
wherein means for setting a mitigation level for one or more processing blocks or subsystem cores on the shared power rail based at least in part on the determined allocated currents for each processing block or subsystem core on the shared power rail comprises means for setting the mitigation level for one or more processing blocks or subsystem cores on the shared power rail based at least in part on the determined operating mode and the determined allocated currents for each processing block or subsystem core on the shared power rail.

27. The shared power rail monitoring circuit of claim 18, wherein means for setting the mitigation level for one or more processing blocks or subsystem cores on the shared power rail based at least in part on the determined allocated currents for each processing block or subsystem core on the shared power rail comprises:
means for determining whether a total of the determined allocated currents of the processing blocks or subsystem cores exceeds a current limit of the shared power rail;
means for incrementing a power mitigation level for one or more processing blocks or subsystem cores on the shared power rail in response to determining that the total of the determined allocated currents of the processing blocks or subsystem cores exceeds the current limit of the shared power rail;
means for determining whether the total of the determined allocated currents of the processing blocks or subsystem cores is less than a hysteresis amount less than the current limit;
means for decrementing a power mitigation level for one or more processing blocks or subsystem cores on the shared power rail in response to determining that the total of the determined allocated currents of the processing blocks or subsystem cores is less than a hysteresis amount less than the current limit; and
means for delaying a period of time associated with the power mitigation level before again determining whether the total of the determined allocated currents of the processing blocks or subsystem cores exceeds a current limit of the shared power rail.

28. An integrated circuit, comprising:
a shared power rail;
a plurality of processing blocks or subsystem cores coupled to the shared power rail; and
a shared power rail monitoring circuit comprising one or more data registers configured to receive operating parameters of one or more of the plurality of processing blocks or subsystem cores, wherein the shared power rail monitoring circuit is configured to:
determine allocated currents for one or more processing blocks or subsystem cores on the shared power rail based on operating parameters of each processing block or subsystem core; and
set a mitigation level for one or more processing blocks or subsystem cores on the shared power rail based at least in part on the determined allocated currents for one or more processing blocks or subsystem cores on the shared power rail.

29. The integrated circuit of claim 28, wherein the shared power rail monitoring circuit is further configured to determine allocated currents for one or more processing blocks or subsystem cores on the shared power rail based on operating parameters of each processing block or subsystem core by determining allocated currents using a set of lookup tables correlated to operating parameters of each processing block or subsystem.

30. The integrated circuit of claim 28, wherein the shared power rail monitoring circuit is further configured to compare a total of allocated currents for all processing blocks or subsystem cores on the shared power rail to a current limit of the shared power rail, and
wherein the shared power rail monitoring circuit is further configured to set a mitigation level for one or more processing blocks or subsystem cores on the shared power rail by setting a mitigation level for one or more processing blocks or subsystem cores on the shared power rail based at least in part on the comparison of the allocated currents to the current limit of the shared power rail.

31. The integrated circuit of claim 28, wherein:
the operating parameters received on the one or more data registers comprises voltage or voltage mode, temperature and operating frequency of each processing block or subsystem core coupled to a shared power rail; and
the shared power rail monitoring circuit is configured with executable instructions to determine allocated currents for each processing block or subsystem core on the shared power rail based on voltage or voltage mode, temperature and operating frequency of each processing block or subsystem core.

32. The integrated circuit of claim 31, wherein the shared power rail monitoring circuit further comprises:
a set of leakage current and dynamic current lookup tables for each processing block or subsystem core coupled to the shared power rail, wherein each leakage current table stores an allocated leakage current indexed to a voltage or voltage mode and a temperature for the respective processing block or subsystem core, and each dynamic current lookup table stores an allocated leakage current indexed to a voltage or voltage mode and a frequency of the respective processing block or subsystem core; and
a rail current summing circuit configured to receive allocated leakage and dynamic currents from the lookup tables and output a total allocated current for processing blocks or subsystem cores coupled to the shared power rail.

33. The integrated circuit of claim 32, wherein the shared power rail monitoring circuit is coupled to the set of leakage current and dynamic current lookup tables for each processing block or subsystem core coupled to a shared power rail, and to the rail current summing circuit, and configured with a policy module configured to:
determine allocated currents for each processing block or subsystem core on the shared power rail based on operating parameters of each processing block or subsystem core by:
receiving voltage or voltage setting, temperature and frequency data from the processing blocks or subsystem cores;
using the voltage or voltage setting, temperature and frequency data as indices in lookup tables to determine a leakage current and a dynamic current of each processing block or subsystem core on the shared power rail and summing the determined leakage and dynamic currents to determine allocated current for each processing block or subsystem core on the shared power rail; and
adding the allocated currents for all processing blocks or subsystem cores on the shared power rail; and
set a mitigation level for one or more processing blocks or subsystem cores on the shared power rail based at least in part on the determined allocated currents for each processing block or subsystem core on the shared power rail by:
comparing a sum of the allocated currents for all processing blocks or subsystem cores on the shared power rail to a limit of the shared power rail;
applying a policy to a result of the comparison to determine a mitigation level for one or more of the processing blocks or subsystem cores on the shared power rail; and
communicating each determined mitigation level to a local level monitor module within a respective processing block or subsystem core.

34. The integrated circuit of claim 28, wherein the shared power rail monitoring circuit is configured to set the mitigation level for one or more processing blocks or subsystem cores on the shared power rail based at least in part on the determined allocated currents for each processing block or subsystem core on the shared power rail by:
determining whether a total of the determined allocated currents of the processing blocks or subsystem cores exceeds a current limit of the shared power rail;
incrementing a power mitigation level for one or more processing blocks or subsystem cores on the shared power rail in response to determining that the total of the determined allocated currents of the processing blocks or subsystem cores exceeds the current limit of the shared power rail;
determining whether the total of the determined allocated currents of the processing blocks or subsystem cores is less than a hysteresis amount less than the current limit;
decrementing a power mitigation level for one or more processing blocks or subsystem cores on the shared power rail in response to determining that the total of the determined allocated currents of the processing blocks or subsystem cores is less than a hysteresis amount less than the current limit; and
delaying a period of time associated with the power mitigation level before again determining whether the total of the determined allocated currents of the processing blocks or subsystem cores exceeds a current limit of the shared power rail.
